(19) United States
(12) Patent Application Publication
(10) Pub. No.: US 2011/0089827 A1
(43) Pub. Date: Apr. 21, 2011

(54) PLASMA DISPLAY PANEL

(75) Inventors: Hiroto Yanagawa, Osaka (JP); Hiroyuki Yamakita, Osaka (JP); Kiyoshi Hishimotodani, Osaka (JP); Keisuke Okada, Osaka (JP)

(73) Assignee: PANASONIC CORPORATION, Osaka (JP)

(21) Appl. No.: 12/991,867

(22) PCT Filed: May 15, 2009
(86) PCT No.: PCT/JP2009/002138

§ 371 Date: Nov. 9, 2010

(30) Foreign Application Priority Data
May 19, 2008 (JP) 2008-130788
May 29, 2008 (JP) 2008-141448

(51) Int. Cl. H01J 17/49; H01J 9/24

(52) U.S. Cl. 313/582; 445/24

(57) ABSTRACT

The present invention provides a PDP especially having a high definition or super high definition cell structure and realizing excellent image display performance by obtaining light-emitting efficiency as favorable as or more favorable than conventional PDPs while suppressing discharge voltage rise.

Therefore, strip-shaped display electrodes 4 and 5 of a PDP 1 are respectively composed of a combination of a transparent electrode 41 and a bus electrode 42 and a combination of a transparent electrode 51 and a bus electrode 52. An electrode gap d between electrodes 41 and 51 falls in a range of 5 μm to 60 μm. A ratio of a total surface area of the electrodes 41 and 51 to a total surface area of discharge cells falls in a range of 0.6 to 0.92. Thus, a discharge start length is larger than the electrode gap d. A product of a total pressure P of a discharge gas and the electrode gap d falls in a range of 13.33 Pa·cm to 133.3 Pa·cm. The discharge gas consists of xenon of 100%. The total pressure P of the discharge gas falls in a range of 2.0 kPa to 53.3 kPa. Thus, a start point of discharge is longer than electrode gap d.

### TECHNICAL FIELD

The present invention relates to a plasma display panel used in TV etc., and in particular to technology for improving display electrodes.

### BACKGROUND ART

In recent years, thin display devices have been rapidly widespread in place of conventional CRT (Cathode Ray Tube) devices with an increase in size of screens of TV sets for household use. Plasma display panels (hereinafter, referred to as “PDP” for short) as well as liquid crystal displays are most common display devices having large-sized thin screens. The plasma display panels perform luminescent display by generating discharge plasma in a tiny cell corresponding to each pixel and converting ultraviolet light generated as a result of the generation into visible light, with use of a phosphor.

Representative PDPs are referred to as AC-driven surface discharge PDPs. Generally, according to this type of the PDPs, a front panel and a back panel are disposed opposing one another with a predetermined distance therebetween. Then, the opposing panels are sealed around the edges thereof. Here, on a surface of the front panel are disposed a plurality of pairs of display electrodes (scan electrodes and sustain electrodes). Also, a dielectric layer and a protective layer are layered on the front panel in the stated order so as to cover the pairs of display electrodes. On a surface of the back panel, on the other hand, are disposed a plurality of address (data) electrodes. Also, a dielectric layer are disposed on the back panel so as to cover the address electrodes, and a plurality of barrier ribs and phosphor layers of RGB colors (each provided between two adjacent barrier ribs) are disposed on the back panel. Each of the front and back panels is made of a glass substrate. An inner space between the panels is a discharge space for plasma discharge. A discharge gas including a predetermined noble gas component such as xenon (hereinafter, expressed as “Xe”) is filled in the discharge space. A plurality of discharge cells are provided across the panel. Specifically, the discharge cells are provided in positions corresponding to where the display electrode pairs and the data electrodes intersect.

When the PDP is driven, a plasma discharge is caused in the discharge gas filled in the discharge space by applying voltage to the display electrode pairs. Charges generated by this discharge are accumulated in the discharge cells as wall charges so as to cancel out potential of the electrodes. The discharge is generated in pulses when the voltage is applied. When potential of the applied voltage is reversed, an electrical field generated by the wall charges accumulated in each of the discharge cells is superimposed so as to have the same polarity as the applied voltage. Thus, an applied voltage necessary to sustain the discharge is reduced. The discharge cells can be selectively ON or OFF by controlling the wall charges.

According to conventional general PDPs, it is known that a correlation (Paschen's law) is established between a product of Pd and a discharge voltage where P is a filled gas pressure and d is an electrode gap between each display electrode pair (“Electrical display device”, Ohmsha, Ltd., 1984, pages 113 to 114). When PDPs are designed, the electrode gap between the display electrode pair and a total pressure of the discharge gas are set so as to be optimal for discharge efficiency and discharge voltage with use of a functional curve that expresses the Paschen's law. Here, the functional curve is a so-called Paschen's curve that is a parabolic curve having a minimum value. The light-emitting efficiency increases with a value larger than the product of Pd showing a minimum value in the Paschen's curve (Paschen's minimum). Reducing a charge start voltage is prioritized, on the other hand, with a value around the product of Pd showing the Paschen's minimum. Therefore, setting is actually made in view of a trade-off that prioritizes either of the effects. Generally, setting is made for commercially-available PDPs such that efficiency is increased while permitting a rise in discharge firing voltage.

Patent literature 1, for example, discloses the following structure. An auxiliary electrode is provided between each display electrode pair. A start point of discharge is located, when viewed down perpendicularly with respect to a display surface, under a small gap between the scan electrode and the auxiliary electrode at a low voltage. Then, an area in which the discharge is sustained is under, when viewed down perpendicularly with respect to the display surface, an electrode gap between the display electrode pair. This is how the PDP in the Patent Literature 1 aims to realize both low voltage drive and high efficiency.

### CITATION LIST

### Patent Literature

### [Patent Literature 1]

Japanese Patent Application Publication No. 2004-214200

### [Patent Literature 2]

Japanese Patent Application Publication No. 1999-149873

### [Non-Patent Literature]

“Development of 0.3 mm Pixel Pitch High-Resolution AC-PDP” by Keiji Ishii (NHK Science & Technical Research Lab.), and EID 2006-62

### INVENTION

### Technical Problem

The technology recited in the Patent Literature 1 is effective to some extent. However, it is difficult to say that both the drive voltage reduction and the high efficiency are realized sufficiently in this technology. Furthermore, an electrode structure might actually become complex, which is likely to increase manufacturing cost and raise a yield problem.

Also, when the electrode gap is simply increased in size based on technology recited in the Non-Patent Literature 1, the discharge firing voltage rises with an improvement in light-emitting efficiency. This causes new problems such as an increase in power consumption of the PDP (especially circuit part) and a cost increase of components of the circuit part.

Also, in recent years, as high-quality TV broadcasting such as digital high-vision broadcasting via land broadcasts has been widespread, high definition display devices and super high definition display devices including PDPs have been desired. The short side length of the cell is 100 μm or less in the super high definition display devices. In order to manufacture such high definition display devices and super high definition display devices, it is naturally necessary to increase the number of discharge cells and downsize the size of the discharge cells. However, just downsizing the size of the discharge cells possibly causes a rise in discharge voltage and reduction in luminance and light-emitting efficiency. For example, when the panel standard is switched from the HD to the full HD so as to obtain super high definition PDPs, the discharge voltage rises by 20 V to 40 V.

Therefore, it is not possible to obtain a sufficient voltage reduction effect in the above conventional technology. Thus, further voltage reduction is desired in order to obtain highly competitive products.

As described in the above, the current PDPs leave problems to be solved.

The present invention has been achieved in view of the above problems, and an aim thereof is to provide a PDP that especially has a high definition cell structure or a super high definition cell structure and can realize an excellent image display performance by suppressing rise in discharge voltage and achieving light-emitting efficiency that is as favorable as or more favorable than the conventional PDPs even if the total pressure of the discharge gas is low.

### Solution to Problem

In order to solve the above problems, the present invention is a plasma display panel comprising: a first substrate having strip-shaped display electrode pairs; and a second substrate that is disposed opposite the first substrate with a discharge space therebetween, the discharge space being filled with discharge gas; and a plurality of discharge cells that are disposed along the display electrode pairs, wherein a ratio of a total surface area of the display electrode pairs to a total surface area of the discharge cells falls in a range of 0.6 to 0.92, and an electrode gap between each of the display electrode pairs falls in a range of 5 μm to 60 μm.

Here, one of each of the display electrode pairs may have a same potential as one of another one of the display electrode pairs that is adjacent to the one of the display electrode pair.

Also, a product of a total pressure of the discharge gas and the electrode gap may fall in a range of 13.33 Pa·cm to 133.3 Pa·cm, and the total pressure of the discharge gas may fall in a range of 2.0 kPa to 53.3 kPa.

A ratio of a partial pressure of xenon in the total pressure of the discharge gas may be 80% or more, or the discharge gas may consist of xenon of 100%.

Furthermore, the first substrate may have a dielectric layer for covering the display electrode pairs, the dielectric layer having a film thickness of 20 μm or less. A reactive permittivity of the dielectric layer preferably falls in a range of 2 to 5.

The dielectric layer may contain SiO₂, and may be formed in a vacuum process.

The discharge space may be partitioned by parallel-arranged barrier ribs into the discharge cells, and the barrier ribs may be arranged at a pitch that falls in a range of 50 μm to 120 μm.

The present invention may be a method for manufacturing a plasma display panel, the method comprising: an electrode forming step of forming, on one surface of a first substrate, display electrode pairs, each of the display electrodes including a bus electrode; a discharge cell forming step of forming a dielectric layer and a protective layer in the stated order so as to cover the display electrode pairs, and subsequently forming discharge cells in areas corresponding to where the display electrode pairs and data electrodes intersect a distance by disposing a second substrate opposite the one surface of the first substrate, a surface of the second substrate having formed thereon the data electrodes, barrier ribs and phosphor layers, wherein in the electrode forming step, an electrode gap between each of the display electrode pairs is set to fall in a range of 5 μm to 60 μm, and the display electrodes are formed such that a ratio of a total surface area of the display electrode pairs to a total surface area of the discharge cells falls in a range of 0.6 to 0.92.

The electrode forming step may include a process of patterning a transparent electrode film formed on the one surface of the first substrate, and in the process, portions of the transparent electrode film that face at least the electrode gaps are eliminated with use of laser, and other portions of the transparent electrode film other than the portions of the transparent electrode film are patterned by wet etching.

Alternatively, the present invention may be a plasma display panel comprising: a first substrate having display electrode pairs; and a second substrate that is disposed opposite the first substrate with a discharge space therebetween, the discharge space being filled with discharge gas; and a plurality of discharge cells that are disposed along the display electrode pairs, wherein a start point of discharge in each of the discharge cells is located, when viewed down perpendicularly with respect to a surface of the first substrate, under at least one of a pair from among the display electrode pairs.

Here, a discharge start length in each of the discharge cells at a beginning of driving of the plasma display panel may be larger than the electrode gap which is a minimum.

It is desirable that a product of a total pressure of the discharge gas and the electrode gap falls in a range of 13.33 Pa·cm to 133.3 Pa·cm. It is preferable that the total pressure of the discharge gas falls in a range of 2.0 kPa to 53.3 kPa, and that an electrode gap between each of the display electrode pairs falls in a range of 5 μm to 60 μm.

It is preferable that a ratio of a partial pressure of xenon in the total pressure of the discharge gas is 80% or more and it is further preferable that the discharge gas consists of xenon of 100%.

Also, each one of each of the display electrode pairs may have a base portion and at least one protruding portion that are connected with one another, the base portion being extended in a direction in which the display electrode pairs extend, and the protruding portions protruding towards the electrode gap from a side surface of the base portion, and the protruding portions of each of the display electrode pairs oppose one another. In this case, it is desirable that, in each of the display electrode pairs, a width of an end portion of each of the protruding portions in the direction is larger than a width of the other end portion of the protruding portion in the direction, the end portion facing the electrode gap and the other end portion being a connecting portion with the base portion. Also, it is preferable that a gap between the opposing protruding portions of each of the display electrode pairs falls in a range of 5 μm to 30 μm. It is desirable that a gap between the base portions of each of the display electrode pairs that oppose one another falls in a range of 100 μm to 300 μm.

It is desirable that a total surface area of portions of the opposing protruding portions that are located, when viewed down perpendicularly with respect to a surface of the first substrate, under each of the discharge cells is equal to or less than a one-tenth of a total surface area of portions of the opposing base portions that are located, when viewed down perpendicularly with respect to a surface of the first substrate, under the discharge cell.

The first substrate may have a dielectric layer for covering the display electrode pairs, the dielectric layer having a film thickness of 20 μm or less. In this case, a reactive permittivity of the dielectric layer may fall in a range of 2 to 5. The dielectric layer may contain SiO₂, and may be formed in a vacuum process.

Also, the discharge space may be partitioned by parallel-arranged barrier ribs into the discharge cells, and the barrier ribs may be arranged at a pitch that falls in a range of 50 μm to 120 μm.

### ADVANTAGEOUS EFFECTS OF INVENTION

In view of the above, inventors have found, after earnest study, that when the PDP has a structure in which microscopic discharge cells are formed and discharge gas having comparatively low total pressure is used, a start length of discharge caused by portions of display electrodes of the pair facing each discharge cell is not a length of a minimum gap between portions of the display electrodes but is a naturally-determined discharge length obtained when the discharge firing voltage is minimum.

In the present invention, the electrode gap, a total pressure of the discharge gas and a ratio of a total surface area of the display electrode pairs to a total surface area of the discharge cells are set based on the above findings. Thus, it is possible to reduce the discharge firing voltage and to reduce the power consumption of the PDP especially having high definition cells or super high definition cells.

Also, an excitation efficiency of Xe can be improved by the reduction of electron energy (proportional to a ratio of electrical field strength to discharge gas pressure) during the discharge. Also, ultraviolet light generation efficiency can be improved. As a result, the light-emitting efficiency can also be improved. In the present invention, the power consumption of the PDP can be reduced by these two effects.

The conventional PDPs have the following problems. When the PDP is designed such that the electrode gap is simply slightly downsized, a ratio of a length of a voltage fall portion to a length of a discharge portion increases due to downsizing of the discharge path. This possibly causes reduction in the light-emitting efficiency. This problem should be considered before considering obtaining reduction effect of the discharge firing voltage.

In order to solve this, the reduction in the light-emitting efficiency can be effectively prevented by taking the following steps. The electrode gap is set to be sufficiently small. The discharge is caused in each discharge cell such that a start point of discharge is located under, when viewed down perpendicularly with respect to a display surface, the display electrode. In this way, when the discharge starts, a discharge path that is not short is naturally determined. Therefore, the discharge is caused away from the front panel, and the discharge loss due to the dispersion of the charge particles on the front panel is reduced.

Furthermore, according to the PDP of the present invention having the strip-shaped display electrodes as described in the above, setting is made such that a ratio of the total surface area of the display electrode pairs to the total surface area of the discharge cell is sufficiently large. Therefore, a length of the discharge path of a main discharge formed after the discharge has started can be as large as a long side pitch of the discharge cell. As a result, the main discharge can be spread in the whole discharge cell. Therefore, the light-emitting efficiency that is equal to or better than the light-emitting efficiency obtained in the conventional structure can be expected.

In this way, the power consumption and the discharge voltage can be reduced in the PDP of the present invention by maintaining the light-emitting efficiency that is comparable to the light-emitting efficiency obtained in the conventional PDP. Therefore, it is possible to realize both the reduction of the power consumption and the reduction of the discharge voltage.

The PDP of the present invention can be obtained in the following case. The discharge gas pressure and an electrode gap d are appropriately reduced in the PDP having high definition cells or super high definition cells such that a product of Pd is smaller than a product of Pd showing a minimum value in the Paschen's curve (hereinafter, referred to as “virtual Paschen's curve”) calculated for a PDP having a general discharge cell size. In this case, the discharge start length does not match a length of the minimum gap between each display electrode pair, and the discharge start length is obtained when the discharge firing voltage is the minimum (i.e. a value corresponding to the product of Pd showing the minimum value in the Paschen's curve). At this time, a start point of discharge in each discharge cell is under, when viewed perpendicularly with respect to the display surface, at least one of the display electrode pair. Therefore, the discharge start length is larger than the minimum electrode gap between the electrodes of the display electrode pair. At this time, the discharge start length is automatically set to a value obtained when the discharge firing voltage is the minimum.

The possible reasons for this are as follow.

According to the conventional PDP having the general cell size, the discharge property is dominantly affected by P (discharge gas pressure) and d (discharge gap) which are parameters in the Paschen's curve. According to the nature of the PDP having the high definition cells or the super high definition cells, however, only a small amount of wall charges exists in each of the discharge cells. Thus, it is considered that the amount of wall charges affects the discharge property of the PDP more dominantly compared to the above parameters in the Paschen's curve. It is important for this kind of PDPs having the high definition cells and the super high definition cells to keep the wall charges by setting the electrode gap d between the display electrodes to be small and setting a width of each electrode to be as large as possible.

In this way, both the high efficiency and the low voltage drive are realized mainly in the PDP of the present invention having microscopic cells by keeping a plenty of wall charges.

Note that the term “discharge start length” in the present invention is a distance between a start point (under one of the display electrode pair) of discharge and a start point (under the other one of the display electrode pair) of discharge, when the discharge cells are viewed perpendicularly with respect to the display surface.

The discharge gas pressure, the discharge gas source and the discharge cell size can be set freely to some extent when the product of Pd is smaller than the product of Pd showing the minimum value in the virtual Paschen's curve. No matter how these values are set, the discharge start length obtained when the discharge firing voltage is the minimum is determined. Therefore, it is possible to efficiently reduce the discharge firing voltage of the PDP when the PDP is driven, and obtain an excellent reduction effect of the power consumption.

Furthermore, since a start point of discharge and an end point of discharge do not depend on a position of the electrode gap in the present invention, the discharge path is spaced away from the surface of the front panel during the discharge in the PDP. Thus, the loss of the charge particles is reduced. Therefore, a plenty of charge particles exist in the discharge space. This makes it possible to obtain the light-emitting efficiency that is comparable to or better than the light-emitting efficiency of the conventional PDP. The inventors of the present application have confirmed after the experiments that such favorable effects are maintained.

Also, the PDP of the present invention can be expected to have longer operating life compared to the conventional PDP. The operating life of the PDP mainly depends on how much the protective layer is sputtered by the discharge. Unfortunately, since the discharge starts at a position in each discharge cell that is located under side portions of the display electrodes of each pair that are close to an electrode gap in the conventional PDP, portions of a protective layer that correspond to the side portions are sputtered comparatively hard. In the present invention, the start point of discharge is a position at which the discharge firing voltage is the minimum, and the discharge path is formed to bulge so as to be away from the front panel. Therefore, in the present invention, it is possible to reduce damage to the protective layer due to the local sputtering. As a result, the operating life of the PDP increases.

Note that further expectable effects of the present invention are reduction of set voltage when the PDP is commercialized, and improvements of the display quality. The conventional PDP has the following problem. The discharge starts at a position in each discharge cell that is under a gap between the opposing display electrodes of each pair. Therefore, when the working accuracy of side portions of the display electrodes of each pair that face the electrode gap varies, discharge voltages of the electrode gaps possibly vary. In order to solve this problem, the start point of discharge is set independently of the electrode gap as shown in the above in the present invention. Therefore, even if the working accuracy of the side portions of the display electrodes varies, the discharge firing voltage is stable. This effect is efficiently obtained especially in the PDP that has the high definition cells or the super high definition cells that are desired to have high working accuracy.

Note that the terms “high definition cells” and “super high definition cells” in the present invention refer to cells that are approximately 160 μm or less and approximately 100 μm or less in short side length, respectively. The present invention is effective especially for PDPs having such microscopic cell structures.

### BRIEF DESCRIPTION OF DRAWINGS

FIG. 1 is a schematic view of an AC-PDP according to a first embodiment of the present invention;

FIG. 2 is a schematic view of the connection between electrodes and drivers;

FIG. 3 is a view showing an example of PDP driving waveforms;

FIG. 4 shows a top view showing a structure of a part of a display electrode pair in the first embodiment;

FIG. 5 shows a top view showing a structure of a part of a conventional display electrode pair;

FIG. 6 is a graph showing a voltage reduction effect in each of examples of the present invention;

FIG. 7A is a schematic sectional view showing a state of a conventional PDP at a beginning of the discharge occurrence, and FIG. 7B is a schematic sectional view showing a state of a PDP in the first embodiment at the beginning of the discharge occurrence;

FIG. 8 is a top view showing a structure of a part of a display electrode pair in a second embodiment;

FIG. 9 is a top view showing a structure of a part of a display electrode pair in a third embodiment;

FIG. 10 is a top view showing a structure of a part of display electrode pair in a fourth embodiment;

FIG. 11 is a top view showing a structure of a part of display electrode pair in a fifth embodiment;

FIG. 12 is a top view showing a structure of a part of display electrode pair in a sixth embodiment;

FIG. 13 is a top view showing a structure of a part of display electrode pair of the conventional PDP;

FIG. 14 is a graph showing a Paschen's curve obtained as a result of measurements of the PDP with use of various types of discharge gas;

FIG. 15 is a graph showing a relation among discharge firing voltage, light-emitting efficiency and an electrode gap;

FIG. 16 is a graph showing the voltage reduction effects of the examples;

FIG. 17A is a photograph showing what happens in a vicinity of the display electrodes at the beginning of discharge in a comparative example, and FIG. 17B is a photograph showing what happens in a vicinity of the display electrodes at the beginning of the discharge in one of examples;

FIG. 18 is a graph showing an example of the Paschen's curve; and

FIG. 19 is for explaining differences between a cell having a general size and a high definition cell.

### DESCRIPTION OF EMBODIMENTS

Embodiments of the present invention are described below. It should be naturally appreciated, however, that the present invention is not limited to the specific embodiment and examples. Various modifications may be made and practiced without departing from the scope of the present invention.

### First Embodiment

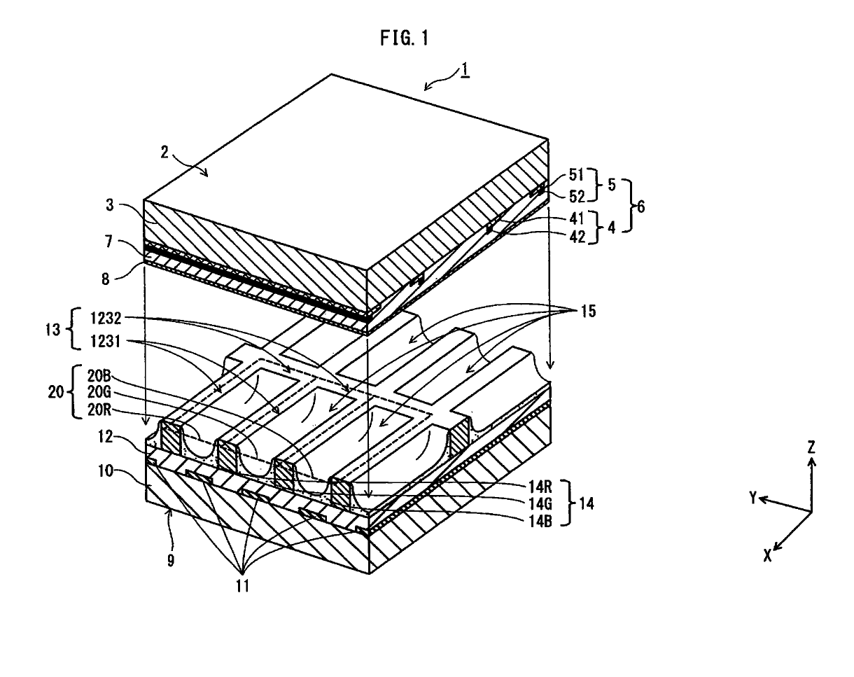

FIG. 1 is a partial schematic view showing a structure of a PDP 1 pertaining to a first embodiment of the present invention. The PDP 1 is mainly characterized by discharge gas and a structure of each display electrodes.

The PDP 1 is manufactured according to a HD (High Definition) panel standard including a high-definition cell structure. Examples of PDPs that are set according to this standard include the following: a PDP having a 37-inch panel with 1024×720 pixels; a PDP having a 42-inch panel with 1024×768 pixels, and a PDP having a 50-inch panel with 1366×768 pixels. The PDPs that are set according to this standard also includes high-resolution panels that are more highly defined (high definition panels and super high definition panels). Examples of such high-resolution panels include a full HD panel with 1920×1080 pixels. The PDP 1 may be a general AC-type NTSC PDP or may be other types of PDPs including XGA and SXGA PDPs.

As shown in FIG. 1, the PDP 1 is composed generally of a first substrate (front panel 2) and a second substrate (back panel 9) that are disposed in spaced face-to-face relation.

The front panel 2 has a front panel glass 3 as a substrate. The plurality of display electrode pairs 6 (each made up of a scan electrode 5 and a sustain electrode 4) are disposed on one main surface of the front panel glass 3. The electrode pairs 6 are disposed in a manner to leave an electrode gap of a predetermined width between the display electrodes of each pair. Each display electrode pair 6 is made of transparent electrodes 51 and 41 and the bus electrode 52 and 42 layered on the transparent electrode 51 and 41, respectively. Each of the transparent electrodes 51 and 41 is made of a strip of a transparent conductive material (0.1 μm in thickness and 150 μm in width), such as Indium Tin Oxide (ITO), Zinc Oxide (ZnO), or Tin Oxide (SnO₂). Each of the bus electrodes 52 and 42 (1 μm in thickness and 30 μm in width) is made of an Ag thick-film (2 μm to 10 μm in thickness), an Al thin-film (0.1 μm to 1 μm in thickness), or a laminated thin-film of Cr/Cu/Cr (0.1 μm to 1 μm in thickness), for example. The bus electrodes 52 and 42 reduce the sheet resistance of the transparent electrodes 51 and 41.

The term “thick-film” used herein refers to a film formed by any of various types of thick film processing according to which a thick-film is formed by applying and burning a paste or the like containing a conductive material. The term “thin-film” used herein refers to a film formed by any of various types of thin-film processing that employs a vacuum process. Examples of thin-film processing include sputtering, ion plating, and electron beam deposition.

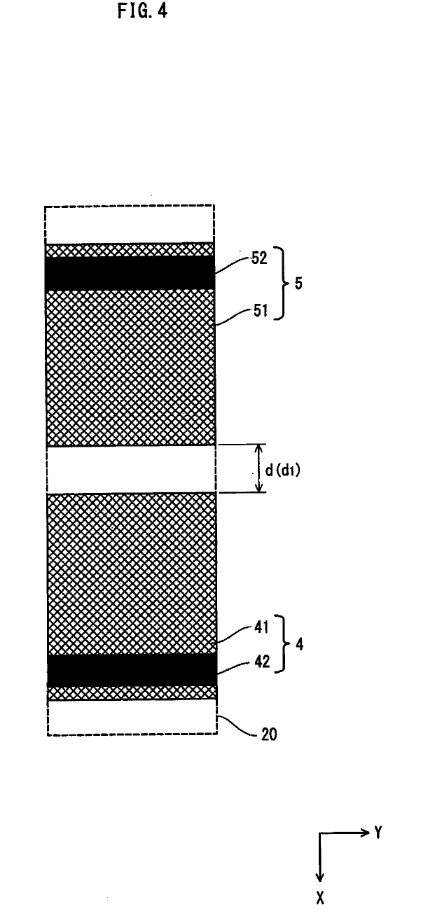

FIG. 4 is a top view along an XY plain surface, showing parts of electrodes 4 and 5 that are located, when viewed down perpendicularly with respect to a display surface, above the discharge cells 20. In FIG. 4, an area encircled by a dotted line corresponds to an inner portion of the discharge cell 20, and indicates a discharge cell surface area when a display surface is looked down. Each of the transparent electrodes 41 and 51 is a strip-shaped electrode so as to be parallel to an extending direction of the transparent electrode (Y direction). A gap between the transparent electrodes 41 and 51 corresponds to a gap d (d1) between the display electrodes 4 and 5 of the pair. The gap d (d1) is set to fall within a range of 5 μm to 60 μm. As shown above, the electrode gap d of the PDP 1 is set to be much narrower than the electrode gap of conventional PDPs. This is for improving a voltage reduction effect by the electrical field concentration.

Furthermore, according to the features of the first embodiment, a ratio of total surface area of the display electrode pairs to a total surface area of the discharge cells is set to fall in a rage of 0.6 to 0.92. This means that a total surface area of the display electrode pairs in the PDP 1 is much larger than a total surface area of the display electrode pairs in the conventional PDPs. In other words, when a cell pitch between two adjacent discharge cells 20 in the X direction is 150 μm, a total width of the transparent electrodes 41 and 51 that face each discharge cell 20 is in a range of 90 μm to 138 μm. When the cell pitch is 360 μm, the total width of the transparent electrodes 41 and 51 that face each discharge cell 20 is in a range of 216 μm to 331.2 μm.

Note that patterning of the display electrodes 4 and 5 is performed by a laser processing or one of the after-mentioned methods such as a photoetching method and a printing method.

On a whole main surface of the front panel glass 3 having disposed thereon the pairs of display electrodes 6, a dielectric layer 7 is formed in a so-called thin-film method such as a CVD method. Here, the dielectric layer 7 is formed using silicon oxide (SiO₂) that is 20 μm or less in thickness. The dielectric layer 7 performs a current limiting function that is specific to an AC-PDP, which is a factor that extends the operating life of AC-PDP as compared with DC-PDPs. With the dielectric layer 7 formed using SiO₂, it is possible to suppress insulation breakdown of a portion of the dielectric layer 7 that faces each electrode gap d even if the electrode gap d is small. Therefore, there are merits that the discharge voltage can be reduced and that it is possible to highly reliably make sure that the insulation breakdown is prevented.

It is desirable that a relative permittivity of the dielectric layer 7 is set to fall in a range of 2 to 5. Thus, a charge density (=relative permittivity/dielectric thickness) can be reduced even when the thickness of the dielectric layer 7 is set to 20 μm or less. Therefore, it is possible to keep a favorable light-emitting efficiency.

The dielectric layer 7 can also be formed in methods such as a slot coater method, a screen printing method and a sol-gel method, with use of low-melting-point glass (35 μm in thickness) that is mainly composed of Lead Oxide (PbO), Bismuth Oxide (Bi₂O₃) or Phosphorus Oxide (PO₄) as well as SiO₂. However, it is preferable to form the dielectric layer 7 having a predetermined thickens with use of SiO₂ in the above-described thin film formation method (vacuum process) in order to suppress the insulation breakdown during driving of the PDP, maintain transparency and form a precise layer structure. With the dielectric layer 7 formed using SiO₂, it is possible to suppress insulation breakdown of a portion of the dielectric layer 7 that faces each electrode gap d even if the electrode gap d is small. Therefore, are merits that the discharge voltage can be reduced and that it is possible to highly reliably make sure that the insulation breakdown is prevented.

A protective layer 8 is disposed on a surface of the dielectric layer 7 that faces toward a discharge space 15. The protective layer 8 is a thin film that protects the dielectric layer 7 from ion bombardment during the discharge, and reduces the discharge firing voltage. The protective layer 8 is formed using MgO having an anti-sputter property and excellent secondary electron emission coefficient γ. The protective layer 8 is formed on the dielectric layer 7 so as to be approximately 1 μm in thickness in the known thin film formation method such as a vacuum deposition method or an ion plating method. Note that a material used for forming the protective layer 8 is not limited to MgO. Therefore, the protective layer 8 may be formed to include at least one metal oxide selected from the group of MgO, CaO, BaO and SrO.

On one surface of a back panel glass 10 which is a substrate of the back panel 9, data electrodes 11 (40 μm in thickness) extend in an X direction and are parallel-disposed at a predetermined pitch (in a range of 50 μm to 120 μm). Each of the data electrodes 11 is composed of one of layers such as an Ag thick film (2 μm to 5 μm in thickness), an Al thin film (0.1 μm to 1 μm in thickness) or a Cr/Cu/Cr laminated thin film (0.1 μm to 1 μm in thickness). A dielectric layer 12 (10 μm in thickness) is disposed on the whole surface of the back panel glass 9 so as to cover the data electrodes 11.

Barrier ribs 13 (approximately 90 μm in height and approximately 40 μm in width) are disposed in a grid pattern (combination of stripes that are parallel-arranged in X and Y direction) on the dielectric layer 12 at positions corresponding to the gaps between the adjacent data electrodes 11. By virtue of the barrier ribs 13 that partition the adjacent discharge cells from one another, erroneous discharge and optical crosstalk are prevented. Each pitch between the barrier ribs 13 (two adjacent barrier ribs 13 facing one another) that are parallel to the data electrodes 11 is the same as a pitch between the adjacent data electrodes 11.

For enabling color display, the phosphor layers 14 of the respective colors of red (R), green (G), and blue (B) are each disposed on the dielectric layer 12 between two adjacent barrier ribs 13 in a manner to cover the side walls of the barrier ribs 13 and a part of a surface of the dielectric layer 12. The composition of each of the phosphor is shown below. The blue (B) phosphor may be composed of BAM:Eu (which is known). The red (R) phosphor may be composed of (Y, Gd) BO₃:Eu or Y₂O₃:Eu, for example. The green (G) phosphor may be composed of Zn₂SiO₄:Mn, YBO₃:Tb or (Y, Gd) BO₃:Tb, for example.

Note that provision of the dielectric layer 12 is optional and the data electrodes 11 may be coated directly with the phosphor layers 14.

The front panel 2 and the back panel 9 are placed in spaced face-to-face relation in a manner that the data electrodes 11 and the display electrode pairs 6 are longitudinally perpendicular to each other. With this positional relationship, the panels 2 and 9 are sealed together along their peripheral edges in a glass frit method. Discharge gas (consisting of Xe of 100%) having a predetermined gas pressure is filled between panels 2 and 9 for the purpose of achieving a high light-emitting efficiency. Note that discharge gas including one or more of He, Xe, Ar, Kr and Ne may be used as the discharge gas instead of the discharge gas consisting of Xe of 100%. However, it is preferable to use a discharge gas in which a partial pressure of Xe is 80% or more in order to obtain the high efficiency.

The discharge space 15 is provided in each of recesses surrounded by the adjacent barrier ribs 13. The discharge cells (also referred to as “sub pixels”) 20 are provided in a matrix as shown by dotted lines in FIG. 1. The discharge cells are provided in positions corresponding to where the adjacent display electrode pairs 6 and the data electrodes 11 intersect across the discharge space 15. Each discharge cell pitch between the adjacent discharge cells in the X direction falls in a range of 150 μm to 360 μm. Each discharge cell pitch between the adjacent discharge cells in a Y direction falls in a range of 50 μm to 120 μm. One pixel (in this case, one side is 150 μm to 360 μm) is composed of three adjacent discharge cells each corresponding to one of RGB colors (20R, 20G and 20B).

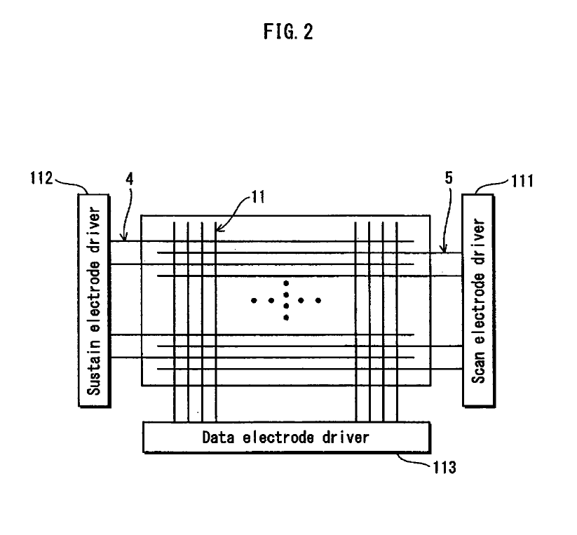

As shown in FIG. 2, a scan electrode driver 111, a sustain electrode driver 112 and a data electrode driver 113 are electrically connected as drive circuits to scan electrodes 5, sustain electrodes 4 and the data electrodes 11 respectively at end portions of the panel in an XY direction. The sustain electrodes 4 are connected to the sustain driver 112 so as to be electrically dependent on one another while the scan electrodes 5 and the data electrodes 11 are respectively connected to the scan electrode driver 111 and the data electrode driver 113 so as to be electrically independent from one another.

(Examples of PDP Driving)

The PDP 1 having the above-stated structure is driven with a known driving circuit (not shown) including the drivers 111-113 in the following manner. First, AC voltage of tens to hundreds of kHz is applied to each gap between the display electrode pairs 6 to generate a discharge in intended discharge cells 20. As a result, the excited Xe atoms emit ultraviolet light and the phosphor layers 14 emit visible light under excitation by the ultraviolet light.

A so-called intra-field time division grayscale display method is one PDP deriving method. According to the method, one field is divided into a plurality of subfields (SF) and each subfield is further divided into a plurality of periods. More specifically, each subfield is composed of the following four periods: (1) an initialization period for resetting or initializing all the display cells to an initial state; (2) an address period for selectively addressing the discharge cells 20 to place the respective discharge cells 20 into a state corresponding to image data input; (3) a sustain period for causing the addressed discharge cells 20 to emit light, and (4) an erase period for erasing wall charges accumulated as a result of the sustain discharge.

In the respective subfields, the following is performed. In the initialization period, wall charges remaining across the entire display screen are initialized (reset). In the subsequent address period, an address discharge is caused exclusively in selected ones of the discharge cells 20 to accumulate wall charges therein. In the sustain period that follows, an AC voltage (sustain voltage) is applied concurrently to all the discharge cells 20 to sustain the discharge for a fixed time period to emit light. As a result, an image is displayed.

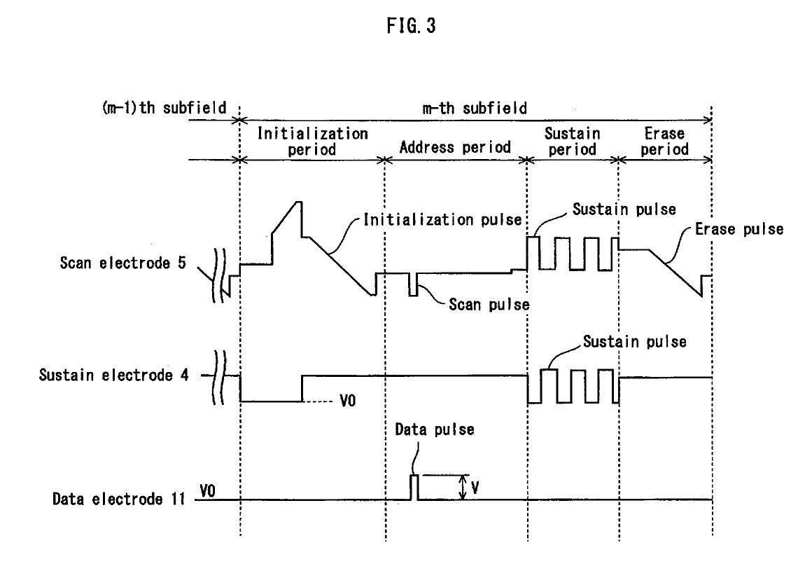

FIG. 3 shows one example of driving waveforms applied in the m-th subfield of one field. As shown in FIG. 3, each subfield is composed of the initialization period, the address period, the sustain period, and the erase period.

The initialization period is provided for erasing wall charges across the entire display area (by causing an initialization discharge). As a result, the influence of previously illuminated cells (influence of previously accumulated wall charges) is eliminated. In the example shown in FIG. 3, a more excellent voltage is applied to the scan electrodes 5 than the voltage applied to the data electrodes 11 and sustain electrodes 4 to cause gaseous discharge in the cells. The electrical charges generated through the gaseous discharge are accumulated on the walls of each cell, so that the potential difference between the data electrodes 11, the scan electrodes 5, and the sustain electrodes 4 is cancelled out. As a result, negative electric charges are accumulated as wall charges on part of the surface of the protective layer 8 relatively close to the scan electrode 5 in each display electrode pair 6. On the other hand, positive electric charges are accumulated as wall charges on part of the surface of the phosphor layers 14 relatively close to the data electrodes 11 as well as on the surface of the portion of the protective layer 8 that faces the sustain electrode 4 in each display electrode pair 6. The negative and positive wall charges of a predetermined magnitude develop a potential between the data electrode 11 and the scan electrode 5 in each display electrode pair 6, and between the scan electrode 5 and the sustain electrode 4 in each display electrode pair 6.

The address period is provided to address the cells selected according to an image signal for the respective subfields (i.e., setting the ON/OFF states of the respective cells). In order to turn ON a cell, a lower voltage is applied to the scan electrode 5 in each display electrode pair 6 than to both the data electrode 11 and the sustain electrode 4 in each display electrode pair 6. That is, a voltage is applied between the data electrode 11 and the scan electrode 5 in each display electrode pair 6 in the same polarity as the potential created by the wall charges. At the same time, a data pulse is applied between the scan electrode 5 and the sustain electrodes 4 in each display electrode pair 6 in the same polarity as the potential created by the wall charges. As a result, a write discharge (address discharge) is generated. Because of the address discharge, negative electric charges are accumulated on part of the surface of the phosphor layer 14 and the surface of the portion of the protective layer 8 relatively close to the sustain electrode 4 in each display electrode pair 6. On the other hand, positive electric charges are accumulated on the surface of the portion of the protective layer 8 relatively close to the scan electrode 5 in each display electrode pair 6. The negative and positive charges develop a predetermined potential between the sustain electrode 4 and the scan electrode 5 in each display electrode pair 6.

The sustain period is provided for sustaining the discharge by extending the duration of the ON state caused by the address discharge so as to maintain the individual cells at the respective luminance levels corresponding to intended gradation levels. In the sustain period, sustain pulses (for example, rectangular-wave voltages of approximately 200 V) are applied to each electrode of the display electrode pair (i.e., the scan electrode 5 and the sustain electrode 4) in a manner that the respective pulses are out of phase from each other. As a result, in each cell set to be ON, a pulse discharge is produced each time the voltage polarity reverses.

With the sustain discharge, the excited Xe atoms present in the discharge space 15 emit the resonance line at 147 nm and the excited Xe molecules emit a molecular beam mainly at 173 nm. Irradiated with the resonance line and the molecular beam, the phosphor layers 14 emit visible light to present a display image. The different colors and grayscale levels of a display image are achieved by combinations of the respective colors of R, G, and B in the individual subfields. Each OFF-state cell having no wall charges accumulated on the protective layer 8 stays black because no sustain discharge occurs therein.

In the erase period, a decreasing erase pulse is applied to the scan electrodes 5 to erase the wall charges.

With the PDP 1 having the above-described structure, the following various effects can be achieved while the PDP is driven.

When the PDP 1 is driven, the sustain discharge (which is caused in high-definition cells (the discharge cells 20)) starts under one of the electrodes of the display electrode pair 6 instead of starting under the electrode gap d (d1) between the electrodes of the display electrode pair 6. The discharge start length is a naturally-determined length obtained when the discharge firing voltage is the minimum in the PDP 1.

In the PDP 1, a small discharge is caused, at the beginning of the driving of the PDP 1, under an inner area of the discharge cell in an electrode width direction (X direction) than side portions of the transparent electrode 41 or 51 under the discharge gap d. Here, the small discharge has a smallest discharge firing voltage at the beginning of the driving of the PDP 1, and has a larger discharge start length than the electrode gap d. This small discharge develops towards the bus electrode 42 or 52 in the X direction to be main discharge that has a long gap and is highly efficient across each display electrode pair 6.

With such discharge adjustment, it is possible to effectively reduce, in the PDP 1, discharge firing voltage. Therefore, power consumption especially in circuit components can be reduced, and excellent reduction effect of the power consumption can be achieved.

Specifically, the gap d (d1) between the display electrodes in the PDP 1 is set so as to have a product of Pd (in a range of 0.1 to 1) that is smaller than a product of Pd showing the minimum value in the Paschen's curve. However, the discharge does not occur under the electrode gap d in the PDP 1 when the product of Pd is smaller than the product of Pd showing the minimum value in the Paschen's curve (the discharge firing voltage is the minimum). Instead, the discharge occurs with a start point of the discharge start length located under one of the display electrodes 4 and 5. These properties of the discharge occurrence are found by the inventors through the study.

The PDP 1 has a high-definition cell structure, and a discharge start length during driving of the PDP 1 is adjusted to a length that corresponds to a product of Pd showing a minimum value of the discharge firing voltage in the Paschen's curve, instead of the electrode gap d. Therefore, the product of Pd is set to be small in the PDP 1. However, a discharge start length is determined so as to obtain a minimum discharge firing voltage. In this way, the power consumption can be effectively reduced.

Note that the electrodes of the display electrode pair 6 are formed to be strip-shaped in the PDP 1. A range of a start point of discharge in each of the discharge cells when the discharge starts is wide. As a result, an occurrence probability of the discharge can be increased, and the reduction effect of the discharge firing voltage can be more expected.

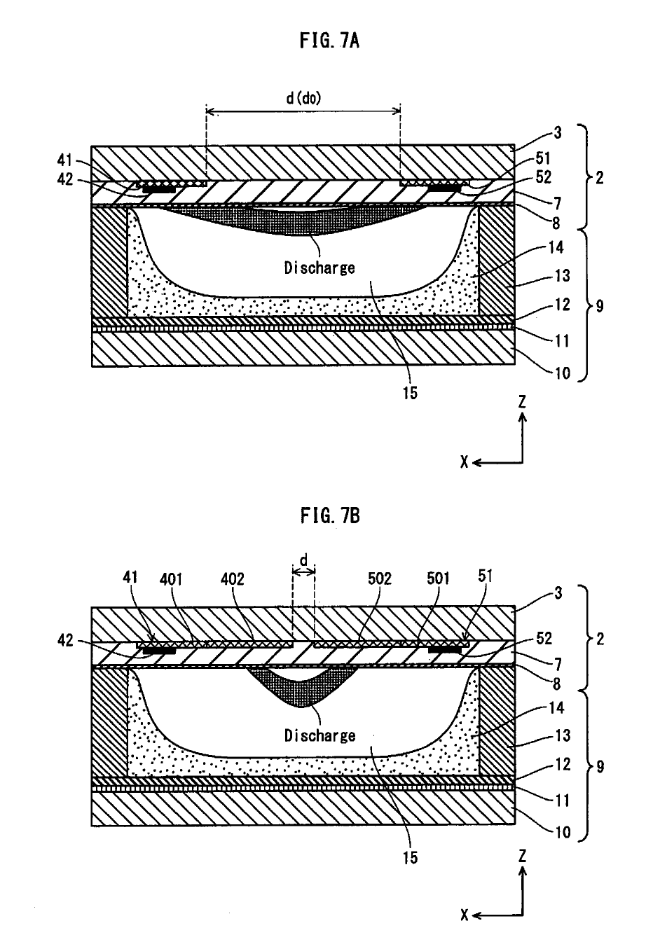

When the discharge starts in each display electrode pair 6, a discharge path is formed so as to be away from the front panel 2 as described later with use of FIG. 7B. Thus, loss of charge particles due to dispersion of the charge particles on a surface of the front panel can be reduced, and a plenty of charge particles can be secured in the discharge space 15. With such an effect, light-emitting efficiency that is equal to or more than conventional light-emitting efficiency can be obtained. In addition, the transparent electrodes 41 and 51 are disposed in the PDP 1 so that a ratio of the total surface area of the transparent electrodes 41 and 51 is larger compared to the total surface area of the discharge cells. A favorable size of the main discharge is maintained by taking an advantage of the surface areas of these transparent electrodes 41 and 51. Here, since large parts of the electrodes are formed with use of a transparent material, external light take-off efficiency from the discharge cells 20 can be improved. As a result, the light-emitting efficiency is improved.

In this way, both a favorable reduction effect of power consumption and light-emitting efficiency that is comparable to the light-emitting efficiency of the conventional PDP can be high-dimensionally realized in the PDP 1.

Also, it is possible to set a total pressure P of the discharge gas to fall in a range of 2.0 kPa to 53.3 kPa when the product of Pd is in a range of 0.1 to 1. In view of the above ranges, the total pressure P and the electrode gap d can be comparatively freely designed in the PDP 1.

Furthermore, it is known that when Xe component in the discharge gas is increased to have a partial pressure of 80% or larger, the light-emitting efficiency can be greatly improved, and the voltage reduction effect can be increased. With a discharge gas consisting of Xe of 100% (single composition discharge gas), a path in which the charge particles flow can be away from the front panel 2 as mentioned in the above in addition to improvement in the light-emitting efficiency. Therefore, a local sputter rate due to the discharge in the MgO film of the protective layer 8 during the driving of the PDP 1 can be reduced. Thus, the PDP can have the long operating life.

Furthermore, since the total pressure of the discharge gas is suppressed in the PDP 1 so as to be lower than the total pressure of the discharge gas in the conventional PDP (e.g. 66.5 kPa to 101 kPa), there is a merit that it is not necessary to adopt a special structure having a resistance against high gas pressure. Therefore, the present invention has a high possibility of realizing a next generation PDP having a large number of microscopic discharge cells (e.g. a short side pitch is in a range of 50 μm to 120 μm).

Also, it is known that when the present invention is applied to a PDP having such a high-definition cells, remarkable reduction effect of a discharge firing voltage and a favorable light-emitting efficiency, in particular, are expected to be maintained compared to the conventional PDP that are comparatively large in a discharge cell size.

Also, the strip-shaped transparent electrodes 41 and 51 are adopted in the PDP 1. Therefore, even if the front panel 2 and the back panel 9 are misaligned in at least a Y direction during manufacture, the electrode gaps d (d1) do not change. Therefore, it is possible to keep minimum the adverse effect due to the misalignment. Especially with this merit, it is possible to obtain effects that manufacturing of the PDP can be comparatively facilitated and excellent possibility of realizing the PDP can be obtained, when the PDP is a high-definition PDP that has a discharge cells each having a short side size of 100 μm or less.

Note that a display electrode structure in which strip-shaped transparent electrodes are disposed with a predetermined electrode gap between adjacent transparent electrodes is known in the art of PDPs. However, the present invention adopts a method that actively uses a product of Pd that is smaller than a product of Pd showing a minimum value in the Paschen's curve, for the PDP having high definition cells or super high definition cells. With this method, the present invention is mainly characterized in that a favorable size of the main discharge is maintained, and this characteristic is different from the conventional technology. This characteristic is obtained by adjusting the electrode gap d to be remarkably smaller in length than the electrode gap in the conventional technology and widening the discharge start length while making setting such that a ratio of a total surface area of the display electrode pairs to the total surface area of the discharge cells is large.

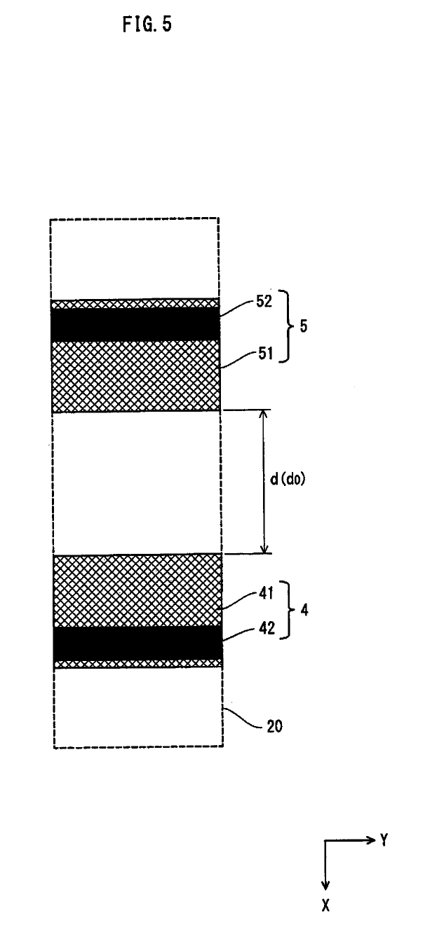

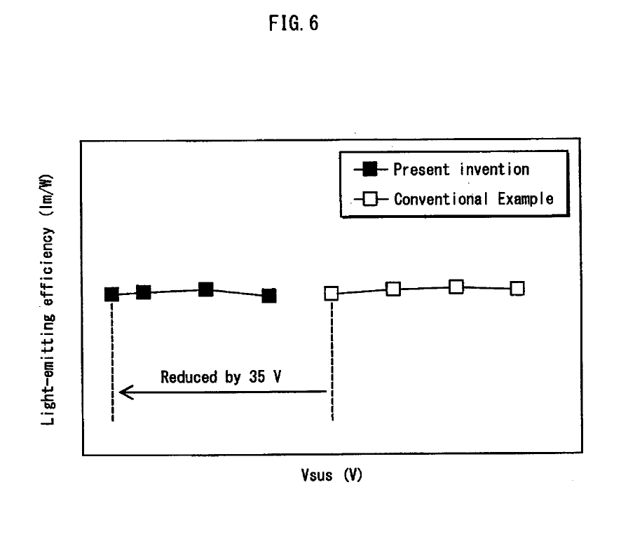

After-mentioned FIG. 6 is a graph showing changes in the voltage reduction efficiency and light-emitting efficiency in the first embodiment (example) in which an electrode width is 105 μm and the electrode gap d is as narrow as 30 μm. The conventional display electrode (60 μm in electrode width and 80 μm in electrode gap d) shown in FIG. 5 is used for the conventional example. In FIG. 6, positions of squares are measuring points when the discharge firing voltage is changed. FIG. 6 shows a case where the discharge firing voltage is decreased towards a left direction so as to obtain almost constant light-emitting efficiency.

As shown in FIG. 6, a range of the discharge firing voltage in which the efficiency can be maintained in the conventional strip-shaped electrodes is a rather high numerical range. In the examples of the present invention, on the other hand, it can be seen that the discharge firing voltage can be reduced by 35 V compared to the discharge firing voltage in the conventional technology, with the light-emitting efficiency maintained.

In this way, the discharge firing voltage can be reduced while the discharge light-emitting efficiency can be maintained in the present invention. The reasons for this are described in the following. Firstly, the product of Pd is set to be smaller than a product of Pd corresponding to a minimum value in the Paschen's curve in order to reduce the discharge voltage. In this way, the discharge start length is set to be longer than the electrode gap d so as to maintain the discharge path. Also, a ratio of a length of a voltage fall portion to the discharge length is set to be comparatively small. Thus, a size of a discharge large enough to contribute to the light emission is obtained. Secondly, the discharge path is away from the front panel 2 so as to avoid dispersion of the charge particles on the surface of the front panel 2 and to reduce discharge loss. Thirdly, the reduction in the discharge firing voltage reduces the electron energy so as to improve the occurrence efficiency of ultraviolet light.

Note that when a so-called ABBA arrangement is adopted in the PDP 1 as a method for arranging the display electrode pairs 6 that are adjacent in the X direction, it is possible to prevent erroneous discharge between the discharge cells 20 that are adjacent in the X direction. In the ABBA arrangement (two of the sustain electrodes 4 or two of the scan electrodes 5 are adjacently arranged in relation to the adjacent display electrodes 6), setting is made such that one of the discharge electrode pairs 6 and one of another display electrode pair 6 that are adjacent to one another have the same potential. This effect is very advantageous in avoiding occurrence of the erroneous discharge between the adjacent discharge cells 20 to obtain high-definition image display performance, when a total surface area of the transparent electrodes 41 and 51 is very large compared to the total surface area of the discharge cells. The connection relation between the sustain electrodes 4 and the drivers 112 and the connection relation between the scan electrodes 5 and the driver 111 are as shown in FIG. 2. Japanese Patent Application Publication No. 2003-114641, for example, recites a structure in which the display electrode pairs are arranged according to the ABBA arrangement.

The following specifically describes an improvement effect of the light-emitting efficiency that can be obtained in the present invention.

FIG. 7A shows a schematic sectional view showing a state of the conventional PDP at the beginning of the discharge. A design of the conventional structure shown in FIG. 7A is based on a product of Pd that is slightly smaller than a product of Pd corresponding to the minimum value in the Paschen's curve. Therefore, as shown in FIG. 7A, the discharge starts in a position close to the electrode gap d of the product of Pd corresponding to the minimum value in the Paschen's curve (i.e. side portions of the transparent electrodes 41 and 51 that are relatively close to the electrode gap d (d0)). In this case, the discharge path is formed under the gap d that is formed to be as small as possible, in the discharge space 15. As a result, the discharge path is close to the surface of the front panel 2.

FIG. 7B, on the other hand, is a schematic sectional view showing a state of the PDP 1 in the first embodiment at the beginning of the discharge. Since the product of Pd is set to be sufficiently smaller than a product of Pd showing the minimum value in the Paschen's curve in the PDP 1, a base point (start point of discharge) of the discharge start length is a position that is under the transparent electrodes 41 or 51, and is where the discharge firing voltage is the minimum. Also, unlike the conventional PDPs, the discharge path after the discharge starts is determined independently of the electrode gap d in the PDP 1. Therefore, nothing is restricted by the electrode gap d (d1) in the PDP 1. Thus, the discharge path is formed to bulge in such a direction as to be away from the front panel 2 in the discharge space 15.

In this way, it is possible to reduce loss of the charge particles that are generated in a vicinity of the front panel 2 during the discharge in the PDP of the present invention. Therefore, the light-emitting efficiency can be favorably improved.

Generally, efficiency of PDPs is evaluated based on the total of light-emitting efficiency, reactive power and circuit loss. The light-emitting efficiency is determined mainly according to the structure of a panel alone. Properties of the reactive power and the circuit loss depend on a structure of each panel, performance of the drive circuits and especially the voltage characteristics. Here, the reactive power is proportional to the square of a voltage value. Here, the reduction effect of the discharge firing voltage is especially increased as described above in the first embodiment. This advantage contributes to effectively reducing each of the reactive power and the circuit loss that depend on the voltage properties. Therefore, it is possible to favorably reduce the reactive power and the circuit loss while obtaining the improvement effect of the light-emitting efficiency by the strip-shaped display electrode pairs 6 in each of which electrodes are disposed with a predetermined discharge gap therebetween in the PDP 1. The efficiency of the PDP as a whole can be improved by various ways.

(Discharge Property According to Discharge Cell Size)

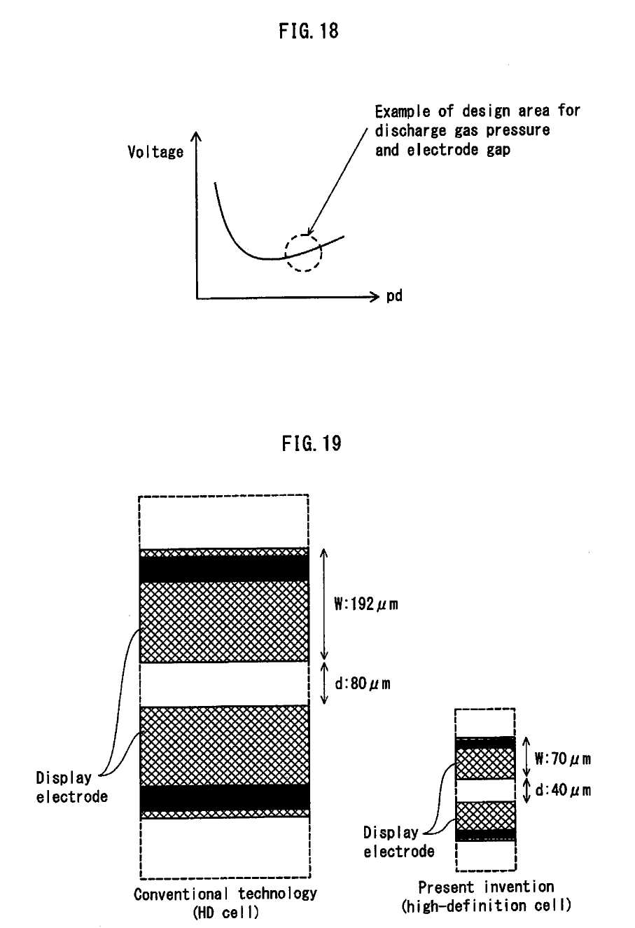

Generally, in view of driving the PDPs on lower power, a size of the electrode gap between each display electrode pair is reduced. Also, in view of improving the efficiency of the PDPs, the size of the electrode gap is increased by extending a length of a discharge portion in each of the discharge cells (that is located under the display electrode pair) to increase a ratio of a surface area of a highly efficient discharge area to a surface area of the discharge cell. Here, the highly efficient discharge area is an area other than an area that is relatively close to the electrode gap. Therefore, when the PDP is designed, the discharge gas pressure and the electrode gap are set, in accordance with the Paschen's law, to be values included in an area closer to the right side than the minimum value of the curve in the Paschen's curve as shown in FIG. 18. Thus, the low power drive and the high efficiency can be balanced in the PDP having a general cell size. Note that it is known that when the discharge gas pressure and the electrode gap of the PDP having the general cell size are set to values included in an area closer to the left side than the minimum value in the Paschen's curve, the efficiency is likely to remarkably decrease.

A PDP having high definition discharge cells each having the short side length of 160 μm or less or super high definition discharge cells each having the short side size of 100 μm or less, on the other hand, has an extremely microscopic structure. Therefore, the discharge property mainly depends on the amount of wall charges secured in the discharge cells rather than the Paschen's law. As with the conventional cells, the loss of wall charges will be problematic when the size of the electrode gap d is increased while the electrode width W is decreased. When the wall charges are lost, the discharge light emission, which is a basic principle of the PDP device, cannot be obtained. Therefore, the image display performance of the PDP is likely to remarkably decrease.

The PDP having such microscopic cells needs to be uniquely designed in order to avoid remarkable reduction of the discharge efficiency and drive incapability. Therefore, according to the present invention, the following is specifically performed. The size of the electrode gap d located above each of the discharge cells is reduced compared to the size of the electrode gap of the conventional PDP (left side of FIG. 19) while the electrode width W is increased (right side of FIG. 19) as shown in FIG. 19. In order to obtain this structure, the discharge gas pressure P and the electrode gap d of the PDP are designed to be values included in the area closer to the left side than the minimal value in the imaginary Paschen's curve. In this way, sufficient amount of wall charges is secured in each of the microscopic discharge cells, and both the high efficiency and the low power drive can be realized. When the present invention is applied to the PDP having the high definition cells or super high definition cells, it is preferable to make setting such that a ratio of the width W of the display electrode to each of the discharge cells is as large as possible (a ratio of the electrode gap d to each of the discharge cells is as small as possible).

The following mainly describes difference between another embodiment of the present invention and the first embodiment. Another embodiment is mainly characterized in the structure of an area around the display electrodes although the overall structure of the PDP is the same as the first embodiment.

### Second Embodiment

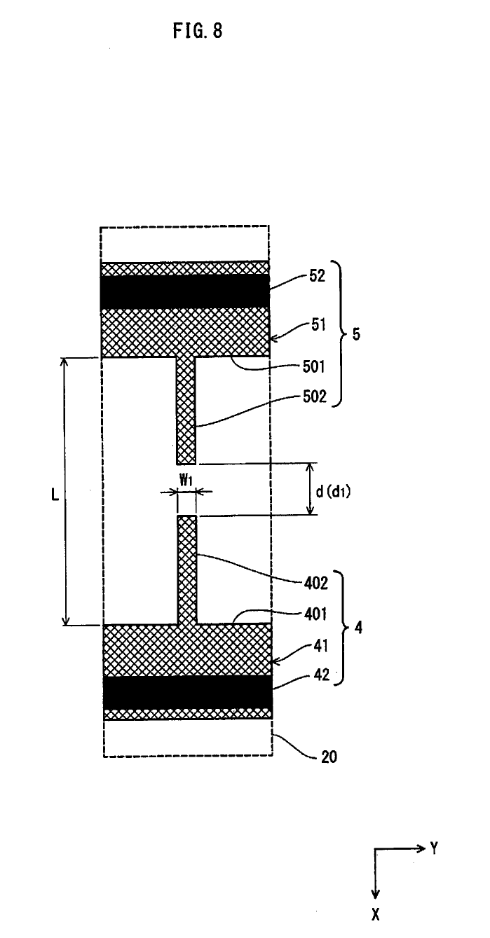

FIG. 8 shown below is a top view along the XY plane, showing parts of the display electrodes 4 and 5 that are located above the discharge cell 20 in a PDP of the second embodiment. In FIG. 8, an area encircled by a dotted line corresponds to an internal portion of each of the discharge cells 20. The transparent electrodes 41 and 51 are respectively composed of strip-shaped base portions 401 and 501 and I-shaped protruding portions 402 and 501. Here, the base portions 401 and 501 are parallel to an extending direction of the transparent electrodes (Y direction), and each of the protruding portions 402 and 502 protrudes from a side of the base portion that opposes the other base potion in an electrode width direction (X direction). End portions of the protruding portions 402 and 502 are disposed so as to oppose one another in the X direction. The minimum gap d (d1) between the display electrodes 4 and 5 is provided between the end portions. When the minimum gap d (d1) is in a range of 5 μm to 30 μm, voltage reduction effect by the electrical field concentration increases, which is favorable. A gap L between the base portions 401 and 402 is set in a range of 100 μm to 300 μm so that the discharge path is long. In this way, the light-emitting efficiency is maintained. A width of each of the protruding portions 402 and 502 in the Y direction (W1) is set to 10 μm, and a width of each of the base portions 401 and 501 in the X direction is set to 50 μm.

Furthermore, setting is appropriately made such that a total surface area of the protruding portions 402 and 502 is equal to or less than a one-tenth of the surface area of the base portions 401 and 501.

Note that such patterning of the display electrodes 4 and 5 can be performed with use of a method such as a photoetching method or a printing method.

As with the PDP 1, the dielectric layer 7 is formed on a whole main surface of the front panel glass 3 on which the display electrode pairs 6 are disposed, with use of a so-called film forming method such as a CVD method. Here, the dielectric layer 7 is formed of silicon oxide (SnO₂) that is 20 μm or less in thickness. With the thickness of 20 μm or less, the dielectric layer 7 can suppress a decrease in the electrical field concentration effect in the protruding portions 402 and 502 of the display electrode pairs 6. Thus, the appropriate electrical field is generated in the discharge space. As a result, the reduction effect of the discharge voltage can be expected, which is favorable.

When the PDP of the second embodiment having the above-described structure is driven, the sustain discharge (which is caused in the discharge cells 20) starts under one of the electrodes of the display electrode pair 6 instead of starting under the electrode gap d (d1) between the electrodes of the display electrode pair 6. The discharge start length is a naturally-determined length obtained when the discharge firing voltage is the minimum in the PDP 1 as with the first embodiment.

In the PDP 1, small discharge occurs, when the PDP 1 is driven, at an inner portion of one of the protruding portions 402 and 502 than the end of the one protruding portion along the electrode width direction. Here, the small discharge has a smallest discharge firing voltage, and has a larger discharge start length than the electrode gap d. This small discharge develops towards the base portions 401 and 501 in the X direction to be main discharge that has a long gap and is highly efficient across the display electrode pair 6.

By such discharge adjustment, it is possible to efficiently reduce the discharge firing voltage in the PDP in the present embodiment. Also, more excellent improvement of the efficiency can be expected compared to the first embodiment.

Also, when the discharge starts under each of the display electrode pairs 6, the discharge path is formed away from the front panel 2 as shown in FIG. 7B. Therefore, it is possible to reduce the loss of the charge particles due to the dispersion of the charge particles along the surface of the front panel. Thus, a plenty of charge particles can be secured in the discharge space 15. Therefore, the light-emitting efficiency equal to or larger than that of the conventional PDP can be obtained with use of the plenty of discharge particles.

As shown in the above, both a favorable reduction effect of power consumption and the excellent improvement effect of efficiency can be high-dimensionally realized in the PDP of the second embodiment, as with the first embodiment. In particular, when each of the display electrode pairs is formed such that the strip-shaped electrodes are partially removed and has the protruding portions 402 and 502, it is possible to suppress power supply to electrodes that does not contribute to light-emitting efficiency when the discharge that has occurred gradually spreads. Thus, it is possible to further favorably realize the reduction of the power consumption and the improvement of the efficiency compared to a PDP having display electrode pairs each having a comparatively large surface area.

Also, setting can be made as follows in the PDP in the present embodiment when the product of Pd is in a range of 0.1 to 1. A total pressure P of the discharge gas is in a range of 2.0 kPa to 53.3 kPa. An electrode gap d between each of the display electrode pair 6 is in a range of 5 μm to 60 μm. In view of the above ranges, the total pressure P and the electrode gap d can be comparatively freely designed in the PDP 1.

Furthermore, it is known that when Xe component in the discharge gas is increased to have a partial pressure of 80% or larger, the light-emitting efficiency can be greatly improved, and the voltage reduction effect can be increased. With a discharge gas consisting of Xe of 100% (single composition discharge gas), a path in which the charge particles flow can be away from the front panel 2 as mentioned in the above in addition to improvement in the light-emitting efficiency. Therefore, a local sputter rate due to the discharge in the MgO film of the protective layer 8 during the driving of the PDP 1 can be reduced. Thus, the PDP can have the long operating life.

Note that it is known that the discharge in the PDP at the beginning of the discharge does not really have an excellent light-emitting efficiency. Therefore, the discharge at the beginning thereof is set to be as small as possible in the PDP in the present invention. As a result, it is possible to actively maintain the discharge that is sufficiently large and improve light-emitting efficiency. Specifically, a total surface area of the protruding portions 402 and 502 is equal to or less than a one-tenth of a total surface area of the base portions 401 and 501. In this way, the discharge (start discharge) can be comparatively small in each of the discharge cells at the beginning of the discharge. Subsequently, the discharge develops towards the base portions 401 and 501 in such a direction as to be away from the electrode gap d to be main discharge that has a long gap and is highly efficient across the display electrode pair 6. Thus, the large main discharge that takes advantage of the long gap between the base portions 401 and 501 can be actively maintained while the start discharge is kept as small as possible. As a result, high light-emitting efficiency can be obtained.

Furthermore, since the protruding portions 402 and 502 are formed with use of the material used for forming the transparent electrodes, external light take-off efficiency from the discharge cells 20 can be improved. As a result, the light-emitting efficiency is improved.

Note that a structure of the display electrodes having the protruding portions that face the electrode gap is known in the field of PDPs, as it is disclosed in Patent Literature 2, for example. However, the present invention is characterized in that: the product of Pd that is smaller than the product of Pd showing the minimum value in the Paschen's curve is actively used; the discharge start length is wider than the electrode gap d; and the discharge firing voltage is kept as small as possible. These characteristics are a lot different from characteristics of the conventional technology.

### Third Embodiment

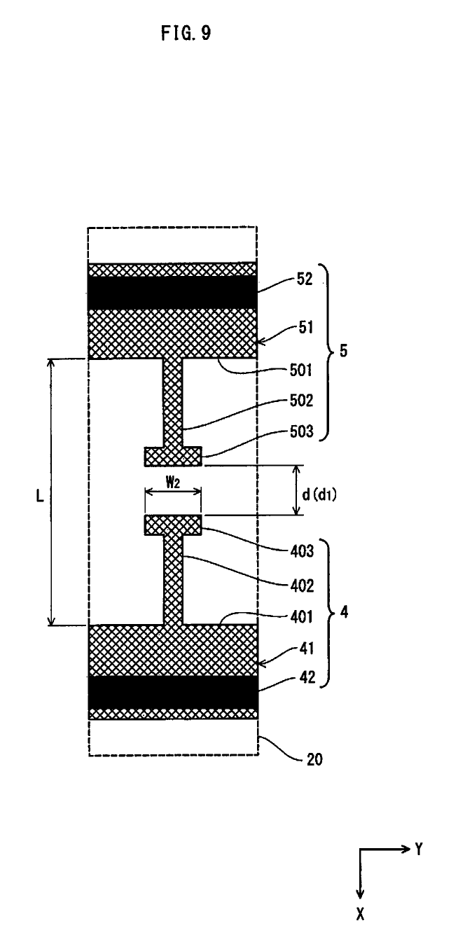

FIG. 9 is a top view along the XY plane, showing forms of parts of the display electrodes 4 and 5 in a PDP of a third embodiment.

Each of the transparent electrodes 41 and 51 in the PDP of the third embodiment includes T-shaped protruding potions (each composed of a main portion 402 or 502 and a end portion 403 or 503). Here, each of the T-shaped protruding portions protrudes from a side of one of the strip-shaped base portions 401 and 501 that opposes a side of the other protruding portion across a gap L. Here, the strip-shaped base portions 401 and 501 are parallel to the extending direction (Y direction) of the transparent electrodes 41 and 51. In this structural example, a minimum gap d (d1) between the display electrodes 4 and 5 is a gap between end portions 403 and 503 of the transparent electrodes 41 and 51. The gap d (d1) is 30 μm in length as with the second embodiment. A length of each of the main portions 402 and 502 in the X direction is 10 μm. A width (W2) of each of the end portions 403 and 503 in the Y direction is 30 μm. Both a width of each of the main portions 402 and 502 in the Y direction and a width of each of the end portions 403 and 503 in the X direction are 10 μm. With such lengths and widths, widths of the main portions 402 and 502 which are connecting portions with the base portions 401 and 501 respectively in the extending direction of the display electrodes 4 and 5 (Y direction) are larger than widths (W2) of the end portions of the protruding portions 403 and 503 in the Y direction.

In the PDP of the present embodiment, the product of Pd is set to 90.0 Pa·cm.

While the PDP of the third embodiment having the above-described structure is driven, the same effects as the second embodiment can be obtained. That is, both the reduction effect of power consumption and improvement in sustaining the light-emitting efficiency can be realized.

Furthermore, in the PDP of the present embodiment, while an electrode surface area of each of the end portions 403 and 503 is larger, a size of an electrode surface area of a portion that is relatively close to the main portions 402 and 502 and is located above the start point of discharges is reduced moderately. Therefore, when the PDP is driven, firing of discharge is facilitated by taking an advantage of the large electrode surface area so as to obtain further favorable reduction effect of the discharge firing voltage.

Also, a size of a discharge developing toward the base portions 401 and 501 (size of the low efficient discharge before becoming the main discharge) in the reduced portion can be effectively suppressed. Thus, a size of a discharge that does not really contribute to light emission can be suppressed to be small.

In such a way, it is possible to actively cause the sustain discharge that contributes to the light-emission while greatly reducing the discharge firing voltage. As a result, the excellent light emitting efficiency can be obtained.

The following Table 1 shows specific effects. Strip-shaped electrode pairs each having an electrode gap d of 140 μm is used in the conventional example for comparison with the present embodiment. The table also shows effects obtained in other embodiments.

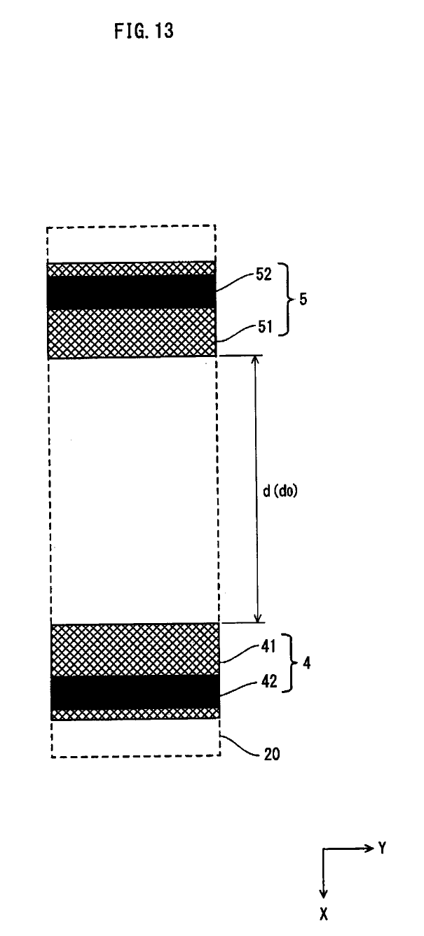

The following is clear from the table 1 showing the results of experiments when the T-shaped protruding portions are used. The discharge firing voltage is further reduced by approximately 20 V compared to the PDP in the second embodiment. The discharge firing voltage is reduced by approximately 50 V compared to the display electrode structure of the strip-shaped electrode shown in FIG. 13.

Generally, it is believed that the discharge firing voltage can be minimized in any kind of PDPs by designing the total pressure P of the discharge gas and the electrode gap d based on the product of Pd corresponding to the minimum value in the Paschen's curve. However, as the experiment results in the Table 1 shows, it is confirmed that more remarkable voltage reduction effect can be obtained compared to the conventional PDPs by designing the product of Pd to be smaller than the product of Pd showing the minimum value in the Paschen's curve as with the present invention when the electrode gap is sufficiently small. Also, the reduction effect of the discharge firing voltage can be obtained with the sufficiently small product of Pd. This shows that the discharge is actually likely to occur independently of the electrode gap d when the electrode gap d is set to be small.

TABLE 1

| | Voltage Reduction |
|---|---|
| | Effect Compared to |
| Display Electrode Structure | Conventional Examples |
| Conventional Example Strip-shaped electrode | — |
| Example 1 (Second Embodiment) I-shaped | −30 V |
| protruding portions | |
| Example 2 (Third Embodiment) T-shaped | −50 V |
| protruding portions | |
| Example 3 (Fourth Embodiment) T-shaped | −120 V |
| protruding portions | |
| Example 4 (Fifth Embodiment) T-shaped | −140 V |
| protruding portions | |

Second embodiment and third embodiment are different only in a shape of the protruding portion.
Fourth embodiment and fifth embodiment are different only in electrode gap d.

Also, Table 1 shows only the strip-shaped electrodes as display electrodes of the conventional example. With a structure including the total pressure P of the discharge gas and the electrode gap d (140 μm) that are the same as those in the conventional example and an electrode structure including the I-shaped protruding portions or the T-shaped protruding portions (when only the electrode shape is the same as the second embodiment and the third embodiment), the discharge firing voltage is higher than the conventional example.

Therefore, it is found that, with the total pressure P of the discharge gas and the electrode gap that are the same as those in the conventional example, the reduction effect of the discharge firing voltage as effective as the present invention cannot be obtained even if the display electrodes have any of the above-stated shapes.

### Fourth Embodiment

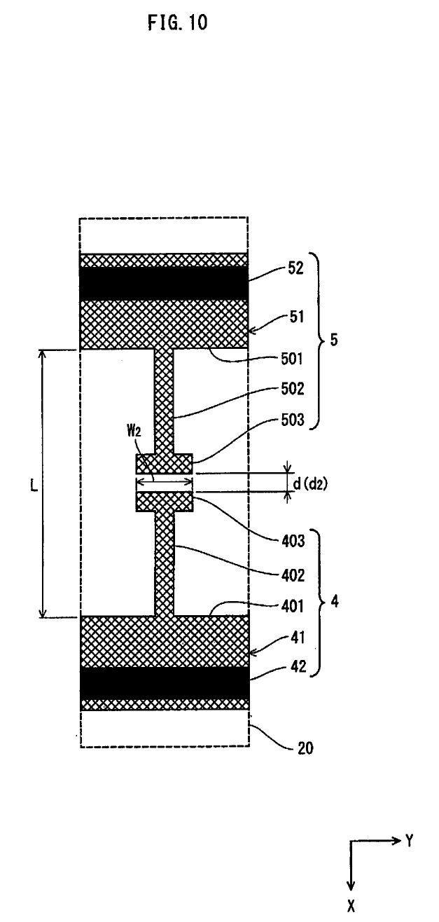

FIG. 10 is a top view along a XY plane, showing parts of the display electrodes 4 and 5 of a PDP of a fourth embodiment. The PDP of the third embodiment is characterized in that the product of Pd is set to 30.0 Pa·cm and the electrode gap d is set to 10 μm based on the display electrode structure of the third embodiment.

In this way, it is possible, while the PDP is driven, to obtain more excellent voltage reduction effect in addition to the same effects as the third embodiment.

That is, the actual effect is that the discharge firing voltage can be reduced by 120 V compared to the conventional strip-shaped electrodes, as shown in Example 3 in the Table 1. The result further shows that the voltage in the fourth embodiment can be further reduced by 90 V compared to the second embodiment and by 70 V compared to the third embodiment.

Note that when the fourth embodiment is compared with the third embodiment in Table 1, it can be seen that, in view of the fact that only difference between the fourth embodiment and the third embodiment is the electrode gap d, a difference in the effect between the third embodiment and the fourth embodiment mainly results from decreasing the size of the electrode gap.

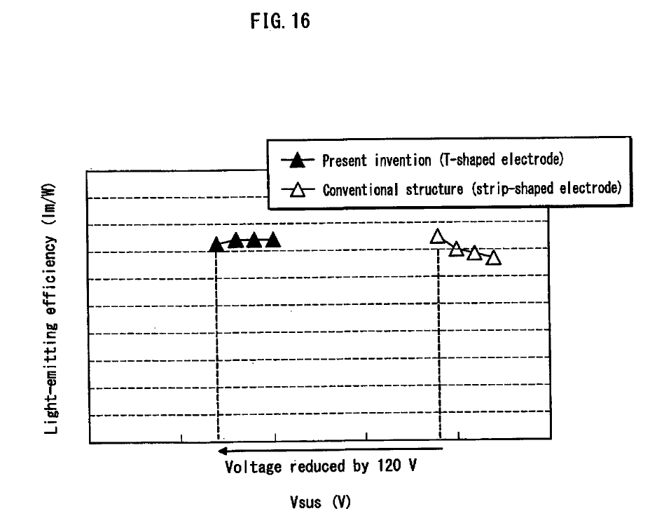

FIG. 16 shown below is a graph showing voltage reduction effect and the light-emitting efficiency in the fourth embodiment compared to the conventional display electrodes shown in FIG. 13. In FIG. 16, positions of triangles each show a measuring point at which the electrode gap d is changed. FIG. 16 shows a case where the electrode gap d is decreased towards a left direction.

As shown in FIG. 16, as the electrode gap d becomes smaller, a certain reduction effect of the discharge voltage can be obtained, in the conventional strip-shaped electrodes. However, when the electrode gap d becomes smaller, a problem arises that the light-emitting efficiency decreases. The possible reasons for this are shown below. As the electrode gap d becomes narrower, electrical field strength increases between each of the display electrode pairs. Therefore, although the discharge starts at low voltage, a size of a length of a voltage fall portion to the discharge length becomes relatively increases in accordance with the discharge start length becoming short. As a result, generation efficiency of ultraviolet light decreases.

In the fourth embodiment, on the other hand, the discharge firing voltage is reduced more compared to the conventional structure (there is an effect that the discharge firing voltage in the same electrode gap d is reduced by approximately 120 V). Also, it is confirmed that even if the electrode gap d is narrowed, almost the same light-emitting efficiency can be obtained regardless of the size of the electrode gap. The possible reasons for this are described in the following. The product of Pd is designed to be smaller than the product of Pd corresponding to the minimum value in the Paschen's curve. Also, the electrode surface area of the protruding portions (a sum of surface areas of protruding portions 402, 403, 502 and 503) is set to be smaller than surface areas of base portions 401 and 501. That is, the discharge start length is determined according to a start point obtained when the discharge firing voltage is the minimum. Also, small discharge is caused between the protruding portions having the small electrode surface areas at the beginning of the discharge occurrence. Highly effective main discharge having the long gap is actively maintained between the base portions 401 and 501 while suppressing the discharge that does not contribute to the light-emitting efficiency. As a result, high light-emitting efficiency can be maintained.

### Fifth and Sixth Embodiments

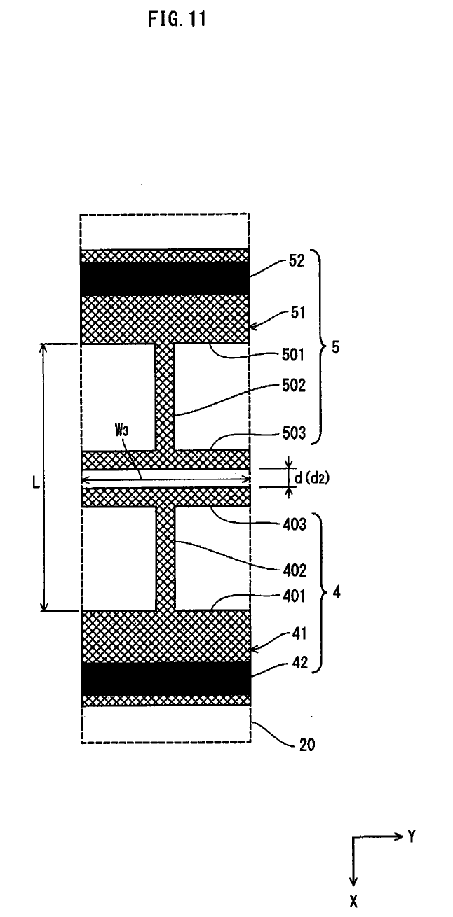

FIG. 11 is a top view along an XY plane, showing the structure of parts of the display electrodes 4 and 5 in the fifth embodiment. The fifth embodiment is characterized by a structure that is different from the display electrode structure of the fourth embodiment in that the end portions 403 and 503 (each having a width W3 in the Y direction) are extended so that the end portions facing discharge cells 20 that are adjacent to one another in the Y direction are integrally formed.

In this way, it is possible, while the PDP is driven, to obtain more excellent voltage reduction effect in addition to the same effects as the fourth embodiment.

That is, since the electrode surface areas of the end portions 403 and 503 are large, unnecessary charge concentration can be suppressed when the voltage is applied. As a result, the discharge firing voltage can be reduced by 140 V compared to the conventional structure (by 20 V compared to the third embodiment), as shown in the Table 1 in the Example 4.

Note that the effect is obtained that the discharge firing voltage is reduced by 20 V compared to the third embodiment. The possible main cause for this is that the width W3 of the end portions 403 and 503 are increased. This shows that effective reduction of the discharge firing voltage can be obtained by increasing the width of the end portions.

Also, in general, when the display electrodes are used that have protruding portions opposing one another with the electrode gap d therebetween, it is necessary to eliminate misalignment between the front panel 2 and the back panel 9 in the manufacturing process in order to maintain the appropriate electrode gap. However, when the display electrodes 4 and 5 in the fifth embodiment are applied, a position of the electrode gap d (d2) in the center of the discharge cell 20 does not change at all even if the misalignment occurs between the front panel 2 and the back panel 9 at least in the Y direction. Therefore, it is possible to minimize the adverse effect due to such misalignment. This merit is especially effective when a PDP is manufactured that has high definition discharge cells each having the short side length of approximately 160 μm or less or super high definition discharge cells each having the short side size of approximately 100 μm or less.

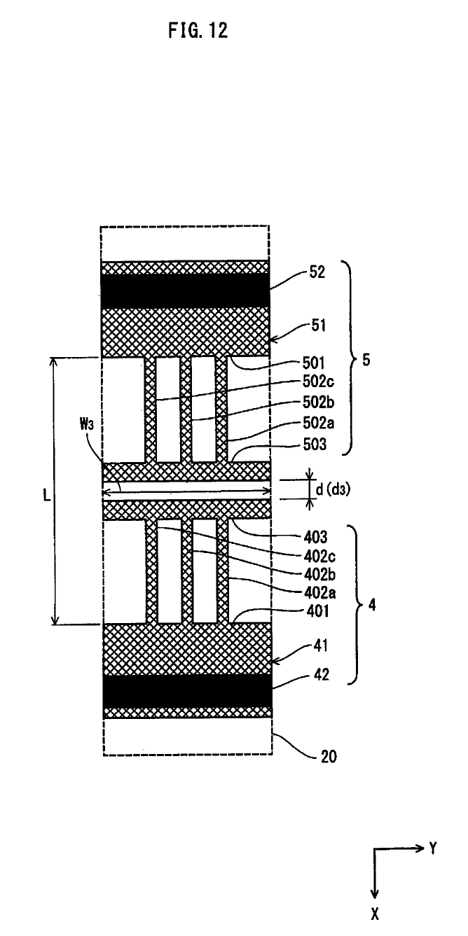

Note that the number of main portions included in each protruding portion facing the discharge cell 20 is not limited to one although the number of main portions 402 and the number of main portions 502 are one. FIG. 12 shows a structure of a sixth embodiment that is based on the fifth embodiment and includes three main portions (402a, 402b and 402c or 502a, 502b and 502c) of protruding portions that face each of the discharge cells 20. With such a structure, the same effect as the fourth embodiment can be obtained. In addition to this, faulty electrification due to the wire disconnection of the main portions is expected to be reduced effectively and a repair rate and occurrence rate of faulty electrification are expected to be improved.

### Experiments

(PDP Having Conventional Structure)

PDPs are display devices that take advantage of the discharge. The so-called Paschen's law is established among the total pressure P of discharge gas, the display electrode gap d and the discharge firing voltage Vf (“Electrical display device”, Ohmsha, Ltd., 1984, pages 113 to 114). A horizontal axis shows products of Pd and a vertical axis shows the discharge firing voltage in the Paschen's curve. The Paschen's curve is a great guideline for designing each parameter in the PDPs.

According to the PDPs, the sustain discharge is caused by the display electrode pairs so as to generate the ultraviolet light in a discharge space in which the discharge gas is filled. The phosphor is irradiated with the ultraviolet light so as to generate the visible light. Xe gas is known as a favorable discharge gas in view of an impact on the global environment and the fact that Xe gas does not have the temperature characteristics. When the Xe partial pressure in the discharge gas is increased, high efficiency can be obtained. However, there is an inconvenience that the voltage also increases. Therefore, the following discharge gas is generally used. The discharge gas is a mixture of the Xe gas for high efficiency purpose and buffer gas including at least one of Ne, Ar, Kr and He for voltage reduction purpose. PDPs that are currently commercially available generally have a discharge gas in which Xe gas at a partial pressure as small as 10% is added to Ne gas, for example.

The inventors of the present invention manufactured PDPs for the examples and conventional examples (also referred to as “comparative examples”), had various experiments and evaluated the obtained data on each of the PDPs. In order to check the characteristics of the conventional PDPs, sample PDPs (comparative examples 1 and 2) were manufactured. One of the PDPs for the first comparative example 1 is a general PDP having a discharge gas containing Xe—Ne gas (10% of Xe and 90% of Ne). The other PDP for the comparative example 2 is a PDP for the high efficiency purpose and has a discharge gas consisting of Xe of 100%.

Firstly, the PDPs for the conventional examples 1 and 2 each are set to have the same cell size and a display electrode gap d of 60 μm.

In processes of manufacturing each of the PDPs for the conventional examples 1 and 2, the front panel and the back panel are attached to one another by a clip, and placed in a vacuum chamber. Then, vacuuming is performed with use of a rotary pump and a cryogenic pump. Subsequently, discharge gas having a predetermined composition is filled between panels.

Each of the PDPs manufactured as above is driven using an aging circuit. At this time, frequency of applied pulse is set to 200 kHz for each of the PDPs.

Then, the discharge cell is illuminated while changing the filled gas pressure in each of the PDPs. At this time, the discharge voltage and the light-emitting efficiency are measured.

Note that the light-emitting efficiency in the present application refers to a quantity of light (per W) emitted from light source. The quantity of visible light (luminous flux) emitted from the light source is expressed by lm, and a unit of the light-emitting efficiency is lm/W. The above-mentioned measuring is performed by calculation based on the following equation.

Light-emitting efficiency={Π×discharge surface area×(ON state luminance−OFF state luminance)/{Vsus×(ON state current−OFF state current)}

Here, the ON state luminance and the OFF state luminance are luminance when the discharge cells are illuminated and luminance when the discharge cells are not illuminated, respectively. Also, the ON state current and the OFF state current are current when the discharge cells are illuminated and current when the discharge cells are not illuminated, respectively. The following shows how the discharge voltage is measured. Firstly, applied voltage is increased so as to illuminate all the discharge cells in the panel. Then, the voltage is decreased so as to measure the minimum voltage when all the discharge cells are illuminated. Note that the minimum voltage is generally referred to as the discharge sustain voltage (Vsus_pd).

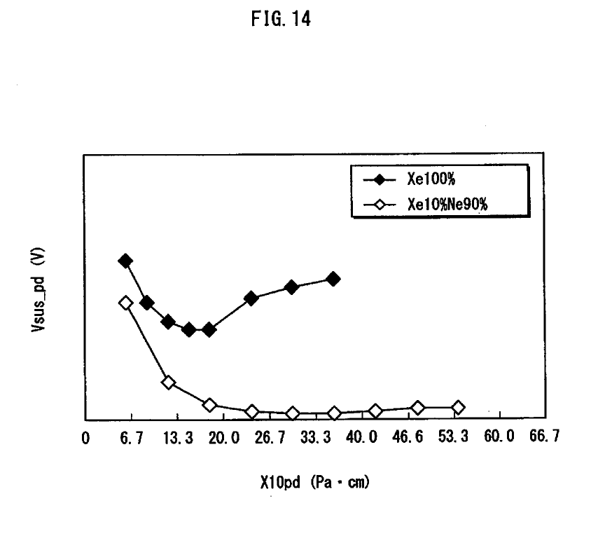

FIG. 14 shows an experimental data (Paschen's curve) obtained as a result of the above measuring. In FIG. 14, the horizontal axis shows Pds and the vertical line shows the discharge firing voltage.

As shown in FIG. 14, it is found that the minimum value in the Paschen's curve is obtained when the product of Pd is in a range of 146.7 Pa·cm to 186.6 Pa·cm in each of the PDPs for the conventional examples 1 and 2. Here, this result is obtained no matter which discharge gas composition each of the PDP has. It is also found that the discharge firing voltage becomes the minimum in this range.

(Relation Among Display Electrodes, Discharge Voltage and Light-Emitting Efficiency in PDPs Having Conventional Structure)

In the conventional PDPs, the light-emitting efficiency improves when the electrode gap becomes larger (“Development of 0.3 mm Pixel Pitch High-Resolution AC-PDP” by Keiji Ishii (NHK Science & Technical Research Lab.), and EID 2006-62”). However, it is also known that as the electrode gap increases, the discharge voltage increase.

Therefore, the above-described property is examined.

Specifically, the PDP having the display electrodes each including the conventional strip-shaped transparent electrode is used (FIG. 9). With this PDP, the electrode gap d is set to be as large as 160 μm in order to obtain high efficiency while the total pressure P of the discharge gas is fixed, in view of the condition that P=30 kPa and d=60 μm when the product of Pd corresponding to a value around the minimum value in the Paschen's curve is 180.0 Pa·cm.

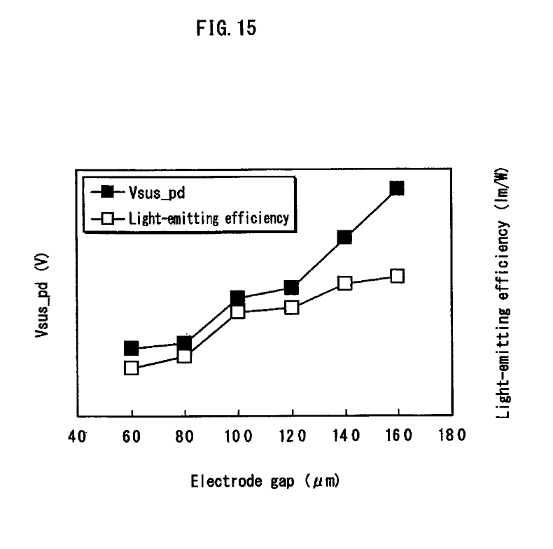

FIG. 15 shows a relation between the discharge voltage and light-emitting efficiency obtained as a result of the above-stated PDP.

As shown in FIG. 15, light-emitting efficiency improves as the electrode gap increase. However, it is confirmed that the discharge voltage rises in proportion to the increase in the electrode gap.

(Examination of Start Point of Discharge in Present Invention)

Next, the following confirmation experiment is performed. When the PDP is designed based on a product of Pd smaller than a product of Pd showing the minimum value in the Paschen's curve, the discharge starts with a larger discharge start length than the electrode gap d when the PDP is driven.

The PDPs of the comparative examples each have a structure in which the strip-shaped transparent electrodes as shown in FIG. 13 are used. Some of the PDPs for the examples each have a structure in which the transparent electrodes having the T-shaped protruding portions of the second embodiment shown in FIG. 8 are used.

When the discharge occurs, near-infrared light is radiated in the discharge cells. This near-infrared light is observed with use of a gate camera (“C8484-05G”Hamamatsu Photonics).

Note that it is known that the observed near-infrared light has some correlation with ultraviolet light generated during the discharge. Therefore, the near-infrared light having wavelength of 780 nm to 860 nm is measured with a gate width of 10 ns. This observation makes it possible to analyze the discharge temporally and spatially.

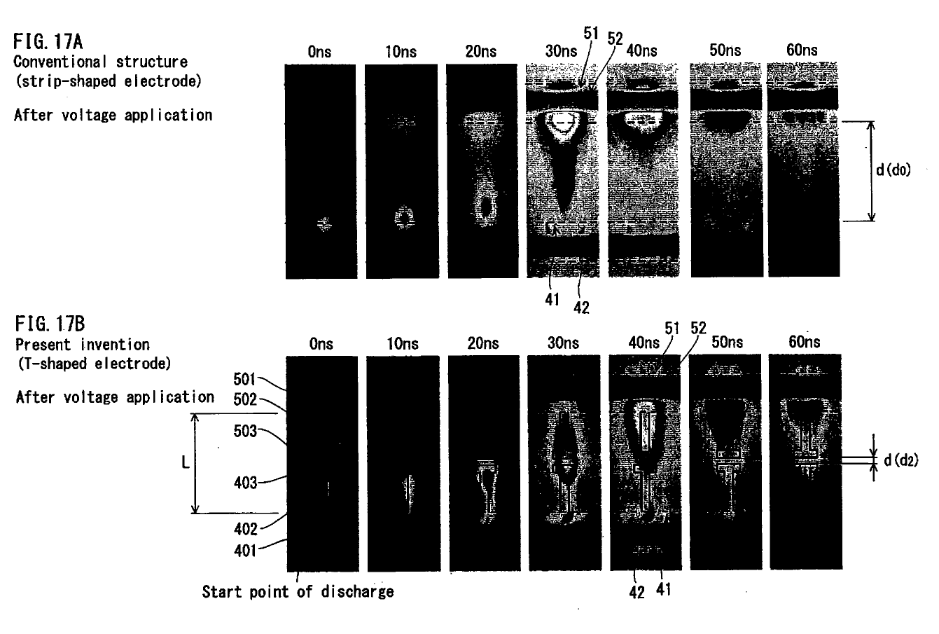

FIGS. 17A and 17B are pictures showing observation images of the display electrodes in the conventional example and one of the examples of the present invention respectively, when the near-infrared light is emitted at the beginning of the discharge occurrence.

As shown in FIGS. 17A and 17B, in each of the conventional pairs of strip-shaped display electrodes, the discharge starts at a side portion of one of the display electrodes that faces the electrode gap d (d0) (side portion of the transparent electrode 41) at a voltage application moment (0 ns) (FIG. 17A).

In the display electrodes having the T-shaped protruding portions in the example, on the other hand, the following is confirmed (FIG. 17B) at the voltage application moment (0 ns). The discharge starts with a larger discharge start length than the electrode gap d (d2), while the start point of discharge in the discharge cell is located over a position relatively close to a connection portion between the main portion 402 and the base portion 401 as shown in FIG. 17B, regardless of the fact that the electrode gap d (d2) between the display electrode pair is very narrow.

Note that it seems in the result shown in FIG. 17B, for example, that a portion of the electrodes around the electrode gap d(2d) contributes less than the start point of discharge of the discharge start length contributes in the present invention. However, it can be said that this portion of the electrodes actively contributes to the discharge voltage reduction since the voltage decreases when the product of Pd is reduced to fall in a range of 30.0 Pa·cm to 90.0 Pa·cm. Note that the start point of discharge is clearly found on an anode side in this picture. Therefore, it is presumed that the start point of discharge on a cathode side exists in an end portion of the protruding portion.

According to the above facts, the following is clear in the present invention. The discharge starts with a gap that is larger than the electrode gap d (d2), and the discharge voltage can be reduced. Also, it is clear that the portion of the electrode around the electrode gap d (d2) contributes to the reduction of the discharge firing voltage more than the start point of discharge.

Note that it is found in another experiment that the product of Pd to be set in the PDP of the present invention is preferably in a range of at least 30.0 Pa·cm to 90.0 Pa·cm. However, when the product of Pd is in a range of 13.33 Pa·cm to 133.3 Pa·cm, almost the same effect can be obtained.

<Other Matters Regarding Second to Sixth Embodiments>

Note that it is preferable that the setting is made in the above-described embodiments such that the electrode gap d between the protruding portions 402 and 502 of each of the display electrode pairs 6 is in a range of 5 μm to 30 μm and the electrode gap L between the base portions 401 and 501 is in a range of 100 μm to 300 μm. This is because an effect larger than the effect of the present invention can be obtained with such setting. However, the present invention is not limited to these ranges.

Note that each of the embodiments has a structure in which the display electrodes 4 and 5 composing each of the display electrode pairs 6 are formed, with the electrode gap therebetween, to be symmetrical and have the same shape. Such structure of the display electrodes 4 and 5 is advantageous in realizing the high efficiency. This is because the wall charges are used as a driving principle of the AC-PDP are accumulated around the dielectric layer 7 while the PDP is driven, and the wall charges can move, each time discharge occurs, between each of the display electrode pairs while being suppressed from being lost.

<Method of Manufacturing PDP>

The following shows an explanatory example of manufacturing the PDP of the present invention. The method of manufacturing the PDP of the present invention has almost the same structure as that of the conventional PDP with the exception that the manufacturing method of the present invention is mainly characterized by a design of the display electrodes and adjustment of the gas pressure and gas component of the discharge gas.

(Manufacturing Front Panel 2)

The display electrode pairs 6 are formed on an upper surface of the front panel glass 3 formed of a soda lime glass that is approximately 1.8 mm in thickness. The following shows steps of manufacturing the display electrode pairs 6 in the printing method.

Firstly, materials for forming the transparent electrodes such as ITO, SnO₂ and ZnO are formed in a thin film process to be approximately 100 nm in final thickness. Then, patterning is performed by etching to form the transparent electrodes 41 and 51.

Alternatively, the electrodes may be formed by taking a step using a laser patterning method. In this case, at first, a thin film (transparent electrode film) formed of the material for forming the transparent electrodes is formed on the front panel glass 3 in a thin film forming method such as a vacuum process. Subsequently, the thin film is partially removed by a laser ablation to form the transparent electrodes 41 and 51 having desired patterns.

After the thin film is formed using the material for forming the transparent electrodes, a patterning process is executed in at least an area corresponding to the electrode gap d formed between each display electrode pair by the laser ablation. Patterning using a wet etching method may be executed in an area corresponding to an area between two adjacent display electrode pairs (i.e. between the adjacent cells). In this way, a portion of the thin film having a comparatively large surface area can be removed efficiently in the wet etching method. The electrode gap d having a fine shape can be accurately formed with laser. This rationally contributes to manufacturing efficiency.

The transparent electrodes 41 and 51 may also be formed in a die coat method and a blade coat method in place of the above-described method. In either of the methods, setting is made such that a ratio of the total surface area of the display electrode pairs to the total surface area of the discharge cells is in a range of 0.6 to 0.92. Also, the electrode gap d is set to be in a range of 5 μm to 60 μm.

A photosensitive paste is prepared by blending Ag powder and an organic vehicle with a photosensitive resin (photodegradable resin). The photosensitive paste is applied to the transparent electrodes 41 and 51. Then, a mask having openings that corresponds to a pattern of bus electrodes to be formed is placed to cover the entire surface of the glass substrate on which the transparent electrodes are formed. In a developing process, the photosensitive resin is exposed to light through the mask. In a subsequent step, the resulting pattern of the photosensitive paste is burned at burning temperatures in a range of about 590° C. to 600° C. Through the above steps, bus electrodes 42 and 52 having a final thickness of a few μm are formed on the transparent electrodes 41 and 51. Conventionally, the width of a finest possible pattern with screen printing is up to 100 μm. In contrast, with the photo-mask method described above, the fine bus electrodes 42 and 52 each having a width of approximately 30 μm is possible. The bus electrodes 42 and 52 may be made of any other metal materials than Ag, and examples of such other materials include Pt, Au, Al, Ni, Cr, tin oxide and indium oxide. In addition, instead of the above-mentioned method, the bus electrodes 42 and 52 may be made by first fabricating a layer of an electrode material using vapor deposition or sputtering, and then by etching the electrode material layer.

Then, the dielectric layer 7 having a final thickness of 20 μm is formed on the display electrode pairs using SiO₂ in a vacuum process such as a CVD method, a sputtering method and an EB method. When the thickness of the protective layer is 20 μm or less, it is possible to suppress an decrease in efficiency of the electrical field concentration between each of the display electrode pairs in the dielectric layer 7. Also, an appropriate electrical field can be formed in the discharge space 15 and the reduction effect of the discharge voltage can be expected. In addition to that, a favorable effect can be obtained in terms of maintaining the reliability.

It is desirable that a relative permittivity of the dielectric layer 7 is set in a range of 2 to 5. Thus, the charge density (=relative permittivity/dielectric thickness) can be reduced even when the dielectric layer 7 is 20 μm in thickness so as to favorably maintain the light-emitting efficiency.

Note that the dielectric layer 7 can be formed in methods such as the slot coater method, the screen printing method and the sol-gel method with use of low-melting-point glass (35 μm in thickness) that is mostly composed of lead oxide (PbO), bismuth oxide (Bi₂O₃) or phosphorus oxide (PO₄). It is desirable that the dielectric layer 7 is formed to have a predetermined thickness with use of SiO₂ in the above-described thin film method (vacuum process) in order to suppress the insulation breakdown during driving of the PDP, maintain preferable transparency that has small time-dependent changes and form a precise layer structure.

A protective layer 8 having a predetermined thickness is formed on a surface of the dielectric layer as a film. The deposition method is used for forming the film, and in an oxygen atmosphere, the deposition source is heated by using a Pierce-type electron beam gun thereby to form a desired film. The conditions of the film formation, such as the amount of the electron beam current, the partial pressure of oxygen, and the temperature of substrate, may be arbitrarily set because such settings have little effect on the composition of the resulting protective layer. In addition, the protective layer 8 may be formed by any other method than the EB method described above. For example, any of various thin-film methods including sputtering and ion plating may be employed.

This is how the front panel 2 is manufactured.

(Manufacturing Back Panel)

First of all, the back panel glass 10 formed of soda lime glass having a thickness of approximately 1.8 mm is prepared. On one surface of the back panel glass 10, a conductive material mainly composed of Ag is applied in strips at a regular space interval to form a plurality of data electrodes 11 each measures a few μm (e.g. approximately 2 μm) in thickness. The data electrodes 11 may be made of any of various metals including Ag, Al, Ni, Pt, Cr, Cu, and Pd. Alternatively, the data electrodes 11 may be made of conductive ceramics, such as metal carbide or metal nitride. Alternatively, the data electrodes 11 may be made of any combination of such materials or may be a laminate of such materials.

When the PDP 1 is manufactured, setting is made such that a distance between the two adjacent data electrodes 11 corresponds to a pitch between the adjacent barrier ribs 13, and falls in a range of 50 μm to 120 μm.

In a subsequent step, a glass paste is applied in a layer of approximately 10 μm thick to cover the entire surface of the back panel glass 10 on which the data electrodes 11 are formed. The applied layer is then burned to be formed into a dielectric layer 12. The glass paste may be made of a lead-based low-melting glass material or an SiO₂ material. Next, the barrier ribs 13 are formed on the surface of the dielectric layer 12 with use of a predetermined pattern. Specifically, a paste of a low-melting glass material is applied and formed into a grid pattern (combination of stripes that are parallel-arranged in X and Y direction) (as shown in FIG. 1) using a sandblast method or a photolithography method.

After completion of the barrier ribs 13, the phosphor layer 14 of one of the red (r) phosphor, the green (G) phosphor and the blue (B) phosphor is formed in respective portions of the dielectric layer 12 exposed between adjacent barrier ribs 13.

The following compositions are possible for the RGB phosphors.

Red phosphor; Y₂O₃; Eu³⁺

Green phosphor; Zn₂SiO₄:Mn

Blue phosphor; BaMgAl₁₀O₁₇:Eu²⁺

One of the known methods such as a static application method, a spray method and a screen printing method may be adopted as the formation method of the phosphor layer.

When the static application method is used, ethyl cellulose as solvent and α-terpineol as medium are added with phosphor powder having average particle diameter of 2.0 μm, and are mixed by a sand mill. As a result of this, a phosphor ink having a viscosity of approximately 15×10⁻³ Pa·s is manufactured. This phosphor ink is placed in a server, and is ejected from a nozzle (60 μm in diameter) of a pump so as to be applied on the adjacent barrier ribs 13. At this time, the panel is moved in a longitudinal direction of the barrier ribs 13 so as to apply the phosphor ink into a stripped pattern. After the application, the phosphor ink is baked for ten minutes at a temperature of 500° C. so as to remove solvent and medium. This is how the phosphor layer 14 is formed.

(Completion of PDP)

The manufactured front panel 2 and the manufactured back panels 9 are attached with use of glass for sealing. Then, air and impurity gas in the discharge space 15 are exhausted so that the discharge space is highly vacuumed (approximately 1.0×10⁻⁴ Pa). Then, discharge gas (whose total discharge gas pressure is in a range of 2.9 kPa to 53.3 kPa) including Xe having a partial pressure of 80% or more (Xe mixture gas such as Ne—Xe gas, He—Ne—Xe gas and Ne—Xe—Ar gas) or a discharge gas consisting of Xe of 100% is filled in the discharge space 15.

Note that it is preferable to make setting for the total pressure P of the discharge gas and the electrode gap d between each of the display electrode pairs such that product of Pd is in a range of 13.33 Pa·cm to 133.3 Pa·cm.

The PDP of the present invention is completed after the above-described processes.

Note that the front panel glass 3 and the back panel glass 10 are each formed of the soda lime glass in the above. However, the soda lime glass is just an example of materials. Therefore, the front panel glass 3 and the back panel glass 10 may be formed of another material.

### INDUSTRIAL APPLICABILITY

The PDP of the present invention is may be used in, for example, an information display terminal used in a transportation facility or a public facility or a display device used as a display of TV set or a computer for household use etc. The present invention can be widely used in high-vision or full-high-vision TV sets, for example, having high definition cells or super high definition cells, and thus has an extremely high industrial applicability.

### REFERENCE SIGNS LIST

1 PDP
2 front panel
4 sustain electrode
5 scan electrode
6 display electrode pair
7, 12 dielectric layer
8 protective layer
9 back panel
11 data electrode
13 barrier rib
14 phosphor layer
15 discharge space
20 discharge cell
401, 501 base portion
402, 402a to 402c, 502, 502a to 502c main portion
403, 503 end portion

1. A plasma display panel comprising:
a first substrate having strip-shaped display electrode pairs, the display electrodes each including a bus electrode; and
a second substrate that is disposed opposite the first substrate with a discharge space therebetween, the discharge space being filled with discharge gas and being partitioned into a plurality of discharge cells at least by parallel-arranged barrier ribs, the discharge cells being disposed along the display electrode pairs, wherein
the barrier ribs are arranged at a pitch that falls in a range of 50 μm to 120 μm,
a start point of discharge in each of the discharge cells is located, when viewed down perpendicularly with respect to a surface of the first substrate, under at least one of a pair from among the display electrode pairs, and
an electrode gap between each of the display electrode pairs falls in a range of 5 μm to 60 μm.

2. The plasma display panel of claim 1, wherein
one of each of the display electrode pairs has a same potential as one of another one of the display electrode pairs that is adjacent to the one of the display electrode pair.

3. The plasma display panel of claim 1, wherein
a product of a total pressure of the discharge gas and the electrode gap falls in a range of 13.33 Pa·cm to 133.3 Pa·cm, and
the total pressure of the discharge gas falls in a range of 2.0 kPa to 53.3 kPa.

4. The plasma display panel of claim 1, wherein
a ratio of a partial pressure of xenon in the total pressure of the discharge gas is 80% or more.

5. The plasma display panel of claim 4, wherein
the discharge gas consists of xenon of 100%.

6. The plasma display panel of claim 1, wherein
the first substrate has a dielectric layer for covering the display electrode pairs, the dielectric layer having a film thickness of 20 μm or less.

7. The plasma display panel of claim 6, wherein
a reactive permittivity of the dielectric layer falls in a range of 2 to 5.

8. The plasma display panel of claim 6, wherein
the dielectric layer contains SiO₂, and is formed in a vacuum process.

9. (canceled)

10. A method for manufacturing a plasma display panel, the method comprising:
an electrode forming step of forming, on one surface of a first substrate, strip-shaped display electrode pairs, each of the display electrodes including a bus electrode;
a discharge cell forming step of forming a dielectric layer and a protective layer in the stated order so as to cover the display electrode pairs, and subsequently forming discharge cells in areas corresponding to where the display electrode pairs and data electrodes intersect a distance by disposing a second substrate opposite the one surface of the first substrate, a surface of the second substrate having formed thereon the data electrodes, barrier ribs and phosphor layers, wherein
in the electrode forming step, an electrode gap between each of the display electrode pairs is set to fall in a range of 5 μm to 60 μm such that a tart point of discharge in each of the discharge cells is located, when viewed down perpendicularly with respect to another surface of the first substrate, under at least one of a pair from among the display electrode pairs, and
in the discharge cell forming step, the discharge cells are partitioned by the barrier ribs at a pitch that falls in a range of 50 μm to 120 μm.

11.-26. (canceled)

27. The plasma display panel of claim 1, wherein
a ratio of a total surface area of the display electrode pairs to a total surface area of the discharge cells falls in a range of 0.6 to 0.92.

28. The plasma display method of claim 10, wherein
in the electrode forming step, the display electrodes are formed such that a ratio of a total surface area of the display electrode pairs to a total surface area of the discharge cells falls in a range of 0.6 to 0.92.

29. The plasma display method of claim 10, wherein
the electrode forming step includes a process of patterning a transparent electrode film formed on the one surface of the first substrate, and
in the process,
portions of the transparent electrode film that face at least the electrode gaps are eliminated with use of laser, and
other portions of the transparent electrode film other than the portions of the transparent electrode film are patterned by wet etching.

30. A plasma display panel comprising:
a first substrate having display electrode pairs, the display electrodes each including a bus electrode; and
a second substrate that is disposed opposite the first substrate with a discharge space therebetween, the discharge space being filled with a discharge gas and being partitioned into a plurality of discharge cells at least by parallel-arranged barrier ribs, the discharge cells being disposed along the display electrode pairs, wherein
the barrier ribs are arranged at a pitch that falls in a range of 50 μm to 120 μm,
a start point of discharge in each of the discharge cells is located, when viewed down perpendicularly with respect to a surface of the first substrate, under at least one of a pair from among the display electrode pairs, and
an electrode gap between each of the display electrode pairs falls in a range of 5 μm to 60 μm.

31. The plasma display panel of claim 30, wherein
a discharge start length in each of the discharge cells at a beginning of driving of the plasma display panel is larger than the electrode gap which is a minimum.

32. The plasma display panel of claim 30, wherein
a product of a total pressure of the discharge gas and the electrode gap falls in a range of 13.33 Pa·cm to 133.3 Pa·cm.

33. The plasma display panel of claim 32, wherein
the total pressure of the discharge gas falls in a range of 2.0 kPa to 53.3 kPa.

34. The plasma display panel of claim 30, wherein
a ratio of a partial pressure of xenon in the total pressure of the discharge gas is 80% or more.

35. The plasma display panel of claim 34, wherein
the discharge gas consists of xenon of 100%.

36. The plasma display panel of claim 30, wherein
each one of each of the display electrode pairs has a base portion and at least one protruding portion that are connected with one another, the base portion being extended in a direction in which the display electrode pairs extend, and the protruding portions protruding towards the electrode gap from a side surface of the base portion, and
the protruding portions of each of the display electrode pairs oppose one another.

37. The plasma display panel of claim 36, wherein
in each of the display electrode pairs, a width of an end portion of each of the protruding portions in the direction is larger than a width of the other end portion of the protruding portion in the direction, the end portion facing the electrode gap and the other end portion being a connecting portion with the base portion.

38. The plasma display panel of claim 36, wherein
a gap between the opposing protruding portions of each of the display electrode pairs falls in a range of 5 μm to 30 μm.

39. The plasma display panel of claim 36, wherein
a gap between the base portions of each of the display electrode pairs that oppose one another falls in a range of 100 μm to 300 μm.

40. The plasma display panel of claim 36, wherein
a total surface area of portions of the opposing protruding portions that are located, when viewed down perpendicularly with respect to a surface of the first substrate, under each of the discharge cells is equal to or less than a one-tenth of a total surface area of portions of the opposing base portions that are located under the discharge cell.

41. The plasma display panel of claim 30, wherein
the first substrate has a dielectric layer for covering the display electrode pairs, the dielectric layer having a film thickness of 20 μm or less.

42. The plasma display panel of claim 41, wherein
a reactive permittivity of the dielectric layer falls in a range of 2 to 5.

43. The plasma display panel of claim 41, wherein
the dielectric layer contains SiO₂, and is formed in a vacuum process.
